(19) United States
(12) Patent Application Publication
(10) Pub. No.: US 2015/0132558 A1
(43) Pub. Date: May 14, 2015

(54) ADHESIVE TAPE

(71) Applicant: DIC CORPORATION, Tokyo (JP)

(72) Inventors: Takeshi Iwasaki, Kitaadachi-gun (JP); Yuki Komatsuzaki, Kitaadachi-gun (JP); Hideaki Takei, Kitaadachi-gun (JP)

(73) Assignee: DIC CORPORATION, Tokyo (JP)

(21) Appl. No.: 14/400,918

(22) PCT Filed: May 16, 2013
(86) PCT No.: PCT/JP2013/063655

§ 371 Date: Nov. 13, 2014

(30) Foreign Application Priority Data
May 21, 2012 (JP) 2012-115584

(51) Int. Cl. C09J 7/02

(52) U.S. Cl. CPC C09J 7/0289
USPC 428/215

(57) ABSTRACT

An adhesive tape includes an adhesive layer on at least one surface of a foam base material, wherein the foam base material is a foam base material having a thickness of 300 μm or less and an interlaminar strength of 6 to 50 N/cm, and the adhesive layer is an adhesive layer having a thickness of 50 μm or less and a 180° peel adhesion force of 0.5 to 4 N/20 mm at a peel rate of 300 mm/min, where the adhesive tape is formed by disposing the adhesive layer having a thickness of 25 μm on a PET base material having a thickness of 25 μm. Favorable impact resistance and reworkability can be realized by this adhesive tape in spite of a small thickness.

### TECHNICAL FIELD

The present invention relates to an adhesive tape by using a foam base material.

### BACKGROUND ART

In portable electronic devices, e.g., electronic notebooks, cellular phones, PHS phones, digital cameras, music players, televisions, tablet type personal computers, notebook type personal computers, and game machines, televisions, monitors, and the like, adhesive tapes have been used for, for example, bonding of panels to protect information display portions, e.g., a liquid crystal display (LCD) and an organic EL display (OEDL), and casings, and fixing of various members and modules.

As for such an adhesive tape, for example, adhesive tapes by using flexible foams as base materials have been disclosed (refer to PTLs 1 and 2). It is disclosed that these adhesive tapes are thin and have good conformability and, therefore, can be favorably applied to fix the components of portable electronic devices.

In recent years, enhancement of functionality of smart phones, tablet type personal computers, notebook type personal computers, game machines, televisions, and other portable electronic devices has been advanced. Volumes of these portable electronic devices increase along with enhancement of functionality easily. Therefore, adhesive tapes used for the portable electronic devices are strongly required to have smaller thicknesses. Meanwhile, the portable electronic devices are subjected to an impact due to drop easily, so that favorable impact resistance is required.

Furthermore, in addition to these characteristics, most of components of the portable electronic devices having higher functionality are expensive components and, therefore, there are high demands for the reworkability in such a way that fixed components can be favorably detached when inconveniences of the portable electronic devices occur in fixing of the components or after the production. In particular, most of thin tabular rigid bodies, e.g., protection panels of information displays and image display modules, are expensive. These tabular rigid components have a problem that cracking and distortion occur easily during rework. Also, the above-described problem have occurred considerably because of upsizing of screens of the information display portions of the portable electronic devices in recent years.

Patent literature 1: Japanese Unexamined Patent Application Publication No. 2010-155969

Patent literature 2: Japanese Unexamined Patent Application Publication No. 2010-260880

### SUMMARY OF INVENTION

### Technical Problem

An issue to be solved by the present invention is to provide an adhesive tape having good impact resistance and exhibiting excellent reworkability in spite of a small thickness.

### Solution to Problem

The present invention solves the above-described issues on the basis of the findings that excellent impact resistance and favorable reworkability can be realized in spite of a small thickness by an adhesive tape. The adhesive tape includes an adhesive layer on at least one surface of a foam base material, and in the adhesive tape, the above-described foam base material is a foam base material having a thickness of 300 μm or less and an interlaminar strength of 6 to 50 N/cm. The above-described adhesive layer is an adhesive layer having a thickness of 50 μm or less and a 180° peel adhesion force of 0.5 to 4 N/20 mm at a peel rate of 300 mm/min, where the adhesive tape, which is formed by disposing the adhesive layer having a thickness of 25 μm on a PET base material having a thickness of 25 μm, is press-bonded to a SUS sheet in an environment at a temperature of 23° C. and a relative humidity of 50% RH by using a 2-kg roller with the number of press bonding cycles of one reciprocating motion and standing is performed for 1 hour in an environment at a temperature of 23° C. and a relative humidity of 50% RH.

### Advantageous Effects of Invention

The adhesive tape according to the present invention has excellent impact resistance at the time of drop in spite of a small thickness and, therefore, fall off of components at the time of drop can be favorably suppressed even in the case where the adhesive tape is used for fixing components of portable electronic devices, on which severe volume restriction is imposed and which is subjected to a drop impact easily. Also, in the case where a tabular rigid component is fixed, even when an inconvenience occurs, the component of the portable electronic device can be separated because of excellent reworkability. Consequently, the adhesive tape according to the present invention can be favorably applied to fixing of protective panels to protect information display portions of portable electronic devices, e.g., smart phones, tablet type personal computers, notebook type personal computers, and game machines, where upsizing of screens has been advanced and the flexibility in design is required, electronic devices, e.g., wall-mounted type televisions and monitors and personal computers, fixing of information display modules, and the like.

### BRIEF DESCRIPTION OF DRAWINGS

FIG. 1 is a conceptual diagram of a test specimen for an impact resistance test, viewed from an upper surface.

FIG. 2 is a conceptual diagram of a test specimen for an impact resistance test, viewed from an upper surface.

FIG. 3 is a conceptual diagram of a test method of an impact resistance test.

### DESCRIPTION OF EMBODIMENTS

An adhesive tape according to the present invention is an adhesive tape including an adhesive layer on at least one surface of a foam base material. The thickness of the foam base material is 300 μm or less and the interlaminar strength thereof is 6 to 50 N/cm. Meanwhile, the thickness of the adhesive layer is 50 μm or less, and as for the adhesion force of the adhesive layer, the 180° peel adhesion force is 0.5 to 4 N/20 mm at a peel rate of 300 mm/min, where the adhesive tape, which is formed by disposing the adhesive layer having a thickness of 25 μm on a PET base material having a thickness of 25 μm, is press-bonded to a SUS sheet in an environment at a temperature of 23° C. and a relative humidity of 65% RH by using a 2-kg roller with the number of press bonding cycles of one reciprocating motion and standing is performed for 1 hour in an environment at a temperature of 23° C. and a relative humidity of 50% RH.

[Foam Base Material]

The foam base material used for the present invention has a thickness of 300 μm or less, preferably 50 to 250 μm, and more preferably 80 to 200 μm. The above-described thickness is employed, so that the elongation of the foam base material can be suppressed while the adhesion properties to an adherend are maintained and good reworkability can be realized in peeling of a rigid body in spite of a small thickness.

Also, the foam base material used for the present invention is a foam base material having an interlaminar strength of 6 to 50 N/cm or more, preferably 8 to 30 N/cm, and more preferably 10 to 20 N/cm. The interlaminar strength is specified to be within the above-described range, so that good adhesiveness to an adherend and excellent impact resistance can be ensured easily. Furthermore, good reworkability can be imparted in the case where a bonded rigid member is peeled or in the case where a bonded rigid member is separated, taken apart, or disassembled to repair, regenerate, or reuse a completed product in order to improve the yield of a portable electronic device at the time of production.

The above-described interlaminar strength is measured by a method described below. One high-adhesion (an adhesive which is not peeled from an adherend and a foam base material at the time of high-speed peeling test described below) adhesive layer having a thickness of 50 μm is bonded to each of both surfaces of a foam base material to be subjected to the interlaminar strength evaluation and, thereafter, aging is performed at 40° C. for 48 hours, so that a double-faced adhesive tape for an interlaminar strength measurement is produced. Subsequently, the double-faced adhesive tape sample, in which one adhesive surface is backed with a polyester film having a thickness of 25 μm, with a width of 1 cm and a length of 15 cm (flow direction and width direction of the foam base material) is press-bonded to a polyester film with a thickness of 50 μm, a width of 3 cm, and a length of 20 cm in an environment at 23° C. and 50% RH with one reciprocating motion of 2-kg roller and standing is performed at 60° C. for 48 hours. After standing at 23° C. for 24 hours, the side bonded to the polyester film having a thickness of 50 μm is fixed to a mounting jig of a high-speed peel tester at 23° C. and 50% RH, and the maximum strength is measured, where the polyester film having a thickness of 25 μm is pulled at a pulling rate of 15 m/min in the 90 degree direction and, thereby, the foam is torn.

The 25% compressive strength of the foam base material used for the present invention is preferably 30 to 500 kPa, more preferably 50 to 450 kPa, and particularly preferably 50 to 140 kPa. The foam base material has a 25% compressive strength within the above-described range and, thereby, more favorable reworkability of the rigid member is obtained easily.

In this regard, the 25% compressive strength is measured in conformity with JIS K 6767. Samples cut into 25 square are stacked until the thickness reaches about 10 mm. The sample is sandwiched by stainless steel sheets having areas larger than the area of the sample, and the strength is measured, where the sample is compressed by about 2.5 mm (corresponding to 25% of the original thickness) at 23° C. and a rate of 10 mm/min.

The density of the foam base material is preferably 0.1 to 0.7 g/cm³, more preferably 0.1 to 0.5 g/cm³, and further preferably 0.15 to 0.45 g/cm³. The above-described density is employed, so that favorable conformability, adhesiveness and, in addition, excellent reworkability can be realized easily in spite of the above-described small thickness. In this regard, the density refers to an apparent density measured in conformity with JIS K 6767 and is obtained by preparing about 15 cm³ of foam base material cut into a rectangle of 4 cm×5 cm and measuring the mass thereof.

The average bubble diameters in the flow direction and the width direction of the foam base material used for the present invention are not specifically limited, but are adjusted to be within the range of preferably 10 to 700 μm, more preferably 30 to 500 μm, and preferably 50 to 400 μm. The average bubble diameters in the flow direction and the width direction are specified to be within the above-described range, so that adhesiveness to an adherend can be ensured easily and the impact resistance can be improved easily. In addition, independent bubbles present in a unit width can be ensured easily.

Meanwhile, the ratio of the average bubble diameter in the width direction to the average bubble diameter in the flow direction is not specifically limited. However, in the case where the flow direction is specified to be 1, 0.25 to 4 times is preferable, 0.33 to 3 times is more preferable, 0.6 to 1.5 times is further preferable, and 0.7 to 1.3 times is particularly preferable. In the case where the ratio is within the above-described range, variations in the flexibility and the tensile strength in the flow direction and the width direction of the foam base material do not occur easily.

The average bubble diameter in the thickness direction of the foam base material used for the present invention is preferably 10 to 100 μm, and more preferably 15 to 60 μm. In the case where the average bubble diameter in the thickness direction is specified to be within the above-described range, as for the thin adhesive tape in the above-described range, favorable conformability and cushioning properties can be realized and excellent adhesiveness is realized in bonding between rigid bodies easily. Also, it is preferable that the average bubble diameter in the thickness direction is specified to be one-half or less, and preferably one-third or less of the thickness of the foam base material because the density and the strength of the foam base material are ensured easily.

Both the ratio of the average bubble diameter in the flow direction of the foam base material to the average bubble diameter in the thickness direction of the foam base material (the average bubble diameter in the flow direction/the average bubble diameter in the thickness direction) and the ratio of the average bubble diameter in the width direction of the foam base material to the average bubble diameter in the thickness direction of the foam base material (the average bubble diameter in the width direction/the average bubble diameter in the thickness direction) are preferably 1 to 15, more preferably 1.5 to 10, and further preferably 2 to 8. In the case where the above-described ratio is employed, the durability against foam interlaminar breakage at the time of drop impact is improved easily. in addition, favorable conformability and cushioning properties in the thickness direction are ensured easily and, in bonding between rigid bodies, good adhesiveness is realized easily, where gaps for entrance of water are not generated.

As for the sizes of the bubbles in the foam base material, the average radius is preferably 50 to 150 μm, and more preferably 70 to 120 μm in the case where the bubble is converted to a sphere on the basis of the average bubble volume calculated from these average bubble diameters.

In this regard, the average bubble diameters in the width direction, the flow direction, and the thickness direction of the foam base material are measured in the manner described below. Initially, the foam base material is cut into 1 cm in both the width direction and the flow direction. Subsequently, the central portion of the cross section of the cut foam base material is observed with a digital microscope (trade name “KH-7700”, produced by HiROX), where foam bubble portions are magnified by a factor of 200 times, and with respect to the cross section in the width direction or the flow direction of the foam base material, the cross section of the foam base material is observed throughout the length in the thickness direction of the base material. In the resulting magnified image, bubble diameters of all bubbles present in 2 mm of cross section, on an actual length before magnification basis, in the flow direction or the width direction are measured, and the average bubble diameter is calculated as an average value thereof. The average bubble diameter is determined from the measurement results of arbitrary 10 places.

The bubble structure of the foam base material used for the present invention is preferably specified to be an independent bubble structure because entrance of water from the cross section of the foam base material can be prevented effectively. As for the shape of the bubble constituting the independent bubble structure, it is preferable that the independent bubbles have a shape in which the average bubble diameter in the flow direction or the width direction or both average bubble diameters of the flow direction and the width direction are larger than the average bubble diameter in the thickness direction because appropriate conformability and cushioning properties are exhibited.

The tensile strengths in the flow direction and the width direction of the foam base material used for the present invention are not specifically limited, but each of them is preferably 300 N/cm² or more, and more preferably 400 to 1,200 N/cm². Also, the tensile elongation at break in a tensile test is not specifically limited, but the tensile elongation in the flow direction is preferably 100% to 1,200%, more preferably 200% to 1,000%, and further preferably 200% to 600%. Degradation in formability and degradation in bonding operability of the adhesive tape can be suppressed with respect to even foamed flexible base materials because of the foam base material having the above-described ranges of tensile strength and tensile elongation. Also, interlaminar breakage and tearing of the foam do not occur easily when the adhesive tape is peeled, and even when interlaminar cracking occurs, ease of peeling of the adhesive tape can be provided.

In this regard, the above-described tensile strengths in the flow direction and the width direction of the foam base material are measured in conformity with JIS K 6767. The maximum strength of a sample with a gauge length of 2 cm and a width of 1 cm is measured by using Tensilon tensile tester in an environment at 23° C. and 50% RH under the measurement condition of a pulling rate of 300 mm/min.

The compressive strength, density, interlaminar strength, tensile strength, and the like of the foam base material can be adjusted appropriately by the material for the base material to be used and the foam structure. The type of the foam base material used for the present invention is not specifically limited insofar as the above-described interlaminar strength and the like can be realized. For example, polyolefin based foams made from polyethylenes, polypropylenes, ethylene-propylene copolymers, ethylene-vinyl acetate copolymers, and the like and rubber based foams made from acrylic rubbers, other elastomers, and the like can be used. Most of all, polyolefin based foams can be used favorably because a foam base material having a thin independent bubble structure exhibiting excellent performance in following the unevenness of the adherend surface, buffer absorption, and the like is produced easily.

It is preferable that the polyethylene based resins be used among the polyolefin based foams by using polyolefin based resins because production with uniform thickness is performed easily and favorable flexibility is provided easily. In particular, the content of the polyethylene based resin in the polyolefin based resin is preferably 40 percent by mass or more, more preferably 50 Percent by mass or more, further preferably 60 percent by mass or more, and particularly preferably 100 percent by mass.

Meanwhile, as for the polyethylene based resins used for the polyolefin based foams, the polyethylene based resins obtained by using metallocene compounds containing tetravalent transition metals as the polymerization catalysts can cross-link the polyolefin based foams homogeneously because the molecular weight distribution is narrow and in the case of a copolymer, copolymer components are introduced into every molecular weight component at almost equal proportion. Consequently, a foam sheet is cross-linked homogeneously and, thereby, it is easy to draw the foam sheet uniformly, as necessary. Therefore, favorably, the thickness of the resulting polyolefin based resin foam becomes uniform on the whole.

Furthermore, the polyolefin based resins constituting the polyolefin based foams may contain polyolefin based resins other than the polyethylene based resins obtained by using metallocene compounds containing tetravalent transition metals as the polymerization catalysts. Examples of such polyolefin based resins include polyethylene based resins other than those described above and propylene based resins. In this regard, the polyolefin based resins may be used alone or at least two types may be used in combination.

Examples of the above-described polyethylene based resins include linear low density polyethylenes, low density polyethylenes, medium density polyethylenes, high density polyethylenes, ethylene-α-olefin copolymers containing 50 percent by weight or more of ethylene, and ethylene-vinyl acetate copolymers containing 50 percent by weight or more of ethylene. They may be used alone or at least two types may be used in combination. Examples of α-olefins constituting ethylene-α-olefin copolymers include propylene, 1-butene, 1-pentene, 4-methyl-1-pentene, 1-hexene, 1-heptene, and 1-octene.

Also, the above-described polypropylene based resins are not specifically limited. Examples include polypropylenes and propylene-α-olefin copolymers containing 50 percent by weight or more of propylene. They may be used alone or at least two types may be used in combination. Examples of α-olefins constituting propylene-α-olefin copolymers include ethylene, 1-butene, 1-pentene, 4-methyl-1-pentene, 1-hexene, 1-heptene, and 1-octene.

The polyolefin based foam may be a cross-linked foam. In the case where an expandable polyolefin based resin sheet is foamed with a thermal decomposition type foaming agent, a cross-linked resin sheet is preferable. If the degree of cross-linking is small, in the case where the foam base material is drawn, bubbles in the vicinity of the surface of the foam sheet may be broken, the surface is roughened, and the adhesiveness to the acrylic adhesive layer may be degraded. If the degree of cross-linking is large, the melt viscosity of the expandable polyolefin based resin composition, as described later, becomes too large, and when the expandable polyolefin based resin composition is heat-foamed, the expandable polyolefin based resin composition becomes difficult to follow foaming, so that a cross-linked polyolefin based resin foam sheet having a predetermined expansion ratio is not obtained and, as a result, the impact absorption property is degraded. Therefore, 5 to 60 percent by mass is preferable, and 20 to 55 percent by mass is more preferable.

Next, a method for manufacturing the polyolefin based resin foam will be described. The method for manufacturing the polyolefin based resin foam is not specifically limited. For example, a method is mentioned, the method including a step to produce an expandable polyolefin based resin sheet by feeding an expandable polyolefin based resin composition, which contains a polyolefin based resin containing 40 percent by weight or more of polyethylene based resin obtained by using a metallocene compound containing a tetravalent transition metal as a polymerization catalyst, a thermal decomposition type foaming agent, a foaming aid, and a colorant to color a foam black, white, or the like, into an extruder to melt-knead and performing extrusion into the shape of a sheet from the extruder, a step to cross-link the resulting expandable polyolefin based resin sheet, a step to foam the expandable polyolefin based resin sheet, and a step to draw a foam sheet by melting or softening the resulting foam sheet and performing drawing toward both or any one of the flow direction and the width direction. In this regard, the step to draw the foam sheet may be performed as necessary and be performed a plurality of times.

Meanwhile, examples of methods for cross-linking the polyolefin based resin foam base material include a method in which the expandable polyolefin based resin sheet is irradiated with ionizing radiation and a method in which the expandable polyolefin based resin composition is blended with an organic peroxide in advance and the resulting expandable polyolefin based resin sheet is heated to decompose the organic peroxide. These methods may be used in combination.

Examples of the ionizing radiation include electron beams, α-rays, β-rays, and γ-rays. The dose of the ionizing radiation is adjusted appropriately in such a way that the gel fraction of the polyolefin based resin foam base material becomes within the above-described preferable range, and a preferable range is 5 to 200 kGy. Also, a uniform foam state is obtained easily by application of the ionizing radiation. Therefore, it is preferable that both surfaces of the expandable polyolefin based resin sheet be irradiated and more preferably, the doses of the two surfaces are equal.

Examples of organic peroxides include 1,1-bis(t-butylperoxy)3,3,5-trimethylcyclohexane, 1,1-bis(t-butylperoxy)cyclohexane, 2,2-bis(t-butylperoxy)octane, n-butyl-4,4-bis(t-butylperoxy)valerate, di-t-butyl peroxide, t-butylcumyl peroxide, dicumyl peroxide, α,α′-bis(t-butylperoxy-m-isopropyl)benzene, 2,5-dimethyl-2,5-di(t-butylperoxy)hexane, 2,5-dimethyl-2,5-di(t-butylperoxy)hexyne-3, benzoyl peroxide, cumylperoxy neodecanate, t-butylperoxy benzoate, 2,5-dimethyl-2,5-di(benzoylperoxy)hexane, t-butylperoxyisopropyl carbonate, and t-butylperoxyallyl carbonate. They may be used alone or at least two types may be used in combination.

If the amount of addition of the organic peroxide is small, cross-linking of the expandable polyolefin based resin sheet may become insufficient, and if the amount is large, decomposition residues of the organic peroxide may remain in the resulting cross-linked polyolefin based resin foam sheet. Therefore, the amount of addition is preferably 0.01 to 5 parts by weight relative to 100 parts by weight of polyolefin based resin, and more preferably 0.1 to 3 parts by weight.

The amount of addition of the thermal decomposition type foaming agent in the expandable polyolefin based resin composition is determined appropriately in accordance with the expansion ratio of the polyolefin based resin foam base material. However, if the amount of addition is small, the foamability of the expandable polyolefin based resin sheet is reduced, and the polyolefin based resin foam base material having a predetermined expansion ratio may not be obtained, and if the amount of addition is large, the tensile strength and the compression recoverability of the resulting polyolefin based resin foam base material may be degraded. Therefore, the amount of addition is preferably 1 to 40 parts by weight relative to 100 parts by weight of polyolefin based resin, and more preferably 1 to 30 parts by weight.

Also, a method for foaming the expandable polyolefin based resin sheet is not specifically limited. Examples thereof include a method in which heating is performed with a hot air, a method in which heating is performed with infrared rays, a method by using a salt bath, and a method by using an oil bath. They may be employed in combination. Most of all, the method in which heating is performed with a hot air and the method in which heating is performed with infrared rays are preferable because differences in appearance of the polyolefin based resin foam base material surface between the surface and the back are small.

The expansion ratio of the foam base material is not specifically limited. However, 1.5 to 6 times is preferable, 1.8 to 5.5 times is more preferable, and 2.5 to 5 times is further preferable because the impact resistance, excellent adhesiveness to an adherend, and reworkability are realized easily by adjusting the 25% compressive strength at a small thickness, the density, the interlaminar strength, and the like within the above-described ranges.

Meanwhile, drawing of the foam base material may be performed after the foam base material is obtained by foaming the expandable polyolefin based resin sheet or be performed while the expandable polyolefin based resin sheet is foamed. In this regard, in the case where the foam base material is drawn after the foam base material is obtained by foaming the expandable polyolefin based resin sheet, the foam base material may be drawn successively without cooling the foam base material while the molten state at the time of foaming is maintained. Alternatively, the foam base material may be cooled and, thereafter, the foam sheet may be heated again to come into the molten or softened state and the foam base material may be drawn.

Here, the molten state of the foam base material refers to the state in which the foam base material is heated in such a way that the both surface temperatures thereof become higher than or equal to the melting point of the polyolefin based resin constituting the foam base material. Also, softening of the foam base material refers to the state in which the foam base material is heated in such a way that the both surface temperatures thereof become temperatures of 20° C. or higher and lower than the melting point temperature of the polyolefin based resin constituting the foam base material. The above-described foam base material is drawn and, thereby, bubbles of the foam base material are drawn and deformed in a predetermined direction, so that a polyolefin based foam having an aspect ratio within a predetermined range can be produced.

Furthermore, as for the drawing direction of the foam base material, drawing is performed in the flow direction or width direction of a long length of expandable polyolefin based resin sheet or in the flow direction and the width direction. In this regard, in the case where the foam base material is drawn in the flow direction and the width direction, the foam base material may be drawn in the flow direction and the width direction at the same time or be drawn in one direction and the other direction on a one-by-one basis.

Examples of methods for drawing the above-described foam base material in the flow direction include a method in which the foam base material is drawn in the flow direction by taking up a length of foam sheet after foaming while cooling at a rate (take-up rate) larger than the rate of feeding the length of expandable polyolefin based resin sheet to a foaming step (feed rate) and a method in which the foam base material is drawn in the flow direction by taking up the foam sheet at a rate (take-up rate) larger than the rate of feeding the resulting foam base material to a drawing step (feed rate).

In this regard, in the former method, the expandable polyolefin based resin sheet expands in the flow direction because of foaming of itself. Therefore, in the case where the foam base material is drawn in the flow direction, the expansion in the flow direction due to foaming of the expandable polyolefin based resin sheet is taken into consideration, and adjustment of the feed rate and the take-up rate of the foam base material is necessary in such a way that the foam base material is drawn in the flow direction by more than the above-described expansion.

Meanwhile, as for the method for drawing the above-described foam base material in the width direction, a method in which the foam base material is drawn in the width direction by holding both end portions of the foam base material in the width direction with a pair of grasping members and moving the pair of grasping members slowly in the directions to increase the distance between the members is preferable. In this regard, the expandable polyolefin based resin sheet expands in the width direction because of foaming of itself. Therefore, in the case where the foam base material is drawn in the width direction, the expansion in the width direction due to foaming of the expandable polyolefin based resin sheet is taken into consideration, and adjustment is necessary in such a way that the foam base material is drawn in the width direction by more than the above-described expansion.

Here, as for the draw ratio of the polyolefin based foam, in the case where drawing is performed in the flow direction and, subsequently, the width direction, the draw ratio in the flow direction is preferably 1.1 to 2.0 times, and more preferably 1.2 to 1.5 times because if the draw ratio is too small, the flexibility and the tensile strength of the polyolefin based resin foam base material may be reduced, and if the draw ratio is too large, the foam base material may be cut during drawing or a foaming gas is released from the foam base material during foaming, so that the expansion ratio of the resulting polyolefin based resin foam base material may be reduced significantly, the flexibility and the tensile strength of the polyolefin based resin foam base material may be reduced, or the quality may become nonuniform.

Meanwhile, the expansion ratio in the width direction is preferably 1.2 to 4.5 times, and more preferably 1.5 to 3.5 times because if the draw ratio in the width direction is too small, the flexibility and the tensile strength of the polyolefin based foam base material may be reduced, and if the draw ratio is too large, the foam base material may be cut during drawing or a foaming gas is released from the foam base material during foaming, so that the expansion ratio of the resulting polyolefin based foam base material may be reduced significantly, the flexibility and the tensile strength of the polyolefin based foam base material may be reduced, or the quality may become nonuniform.

In this regard, in the case where drawing is performed in the width direction and, subsequently, the flow direction, it is preferable that the draw ratio in the width direction is specified to be the same as the draw ratio in the above-described flow direction and the draw ratio in the flow direction is specified to be the same as the draw ratio in the above-described width direction.

The foam base material may be colored in order to realize the design, the light shielding effect, the hiding effect, the light reflection effect, and the lightfastness of the adhesive tape. The colorants may be used alone or at least two types may be used in combination.

In the case where the light shielding effect, the hiding effect, the light reflection effect, and the lightfastness are given to the adhesive tape, the foam base material is colored black. As for the black colorant, carbon black, graphite, copper oxide, manganese dioxide, aniline black, perylene black, titanium black, cyanine black, activated carbon, ferrite, magnetite, chromium oxide, iron oxide, molybdenum disulfide, chromium complex, composite oxide based black coloring matter, anthraquinone based organic black coloring matter, and the like can be used. Among them, carbon black is preferable from the viewpoint of the cost, the availability, the insulating property, and the heat resistance to endure the temperatures in the step to extrude the expandable polyolefin based resin composition and the heat-foaming step.

In the case where the design and the light reflection effect are given to the adhesive tape, the foam base material is colored white. As for the white colorant, inorganic white colorants, e.g., titanium oxide, zinc oxide, aluminum oxide, silicon oxide, magnesium oxide, zirconium oxide, calcium oxide, tin oxide, barium oxide, cesium oxide, yttrium oxide, magnesium carbonate, calcium carbonate, barium carbonate, zinc carbonate, aluminum hydroxide, magnesium hydroxide, calcium hydroxide, zinc hydroxide, aluminum silicate, calcium silicate, barium sulfate, calcium sulfate, barium stearate, zinc flower, talc, silica, alumina, clay, kaolin, titanium phosphate, mica, gypsum, white carbon, diatomaceous earth, bentonite, lithopone, zeolite, and sericite, organic white colorant, e.g., silicone based resin particles, acrylic resin particles, urethane based resin particles, and melamine based resin particles, and the like can be used. Among them, aluminum oxide and zinc oxide are preferable from the viewpoint of the cost, the availability, the color tone, and the heat resistance to endure the temperatures in the step to extrude the expandable polyolefin based resin composition and the heat-foaming step.

Also, as for the expandable polyolefin based resin composition, known materials, for example, a foaming aid, e.g., a plasticizer, an antioxidant, and a zinc oxide, a bubble core adjustment material, a thermal stabilizer, a flame retarder, e.g., aluminum hydroxide or magnesium hydroxide, an antistatic agent, a filler, e.g., glass or plastic hollow balloons•beeds, a metal powder, or a metal compound, an electrically conductive filler, a thermally conductive filler, and the like may be contained optionally in the resin, as necessary, within the bounds of not impairing the properties of the polyolefin based resin foam base material. The polyolefin based resin foam base material used for the adhesive tape according to the present invention is preferably 0.1 to 10 percent by mass, and preferably 1 to 7 percent by mass relative to the polyolefin based resin in order to maintain appropriate conformability and cushioning properties.

In this regard, in the case where the above-described colorant, thermal decomposition type foaming agent, and foaming aid are blended into the expandable polyolefin based resin composition, it is preferable that a master batch be prepared with a thermoplastic resin having high compatibility with the expandable polyolefin based resin composition and the expandable polyolefin based resin composition in advance before feeding to the extruder from the viewpoint of prevention of color heterogeneity, irregular foaming, and poor foaming.

The foam base material may be subjected to a surface treatment, e.g., a corona treatment, a flame treatment, a plasma treatment, a hot air treatment, an ozone•ultraviolet ray treatment, or an easy-to-adhere treatment agent coating, in order to improve the adhesiveness to the adhesive layer or other layers. In the surface treatment, the wetting index indicated by a wetting reagent is specified to be 36 mN/m or more, preferably 40 mN/m, and further preferably 48 mN/m, so that good adhesiveness to the adhesive is obtained. The foam base material exhibiting improved adhesiveness may be bonded together with the adhesive layer in a continuous step or may be subjected to temporary take-up. In the case where the foam base material is taken up temporarily, in order to prevent a blocking phenomenon between the foam base materials exhibiting improved adhesiveness, it is preferable that the foam base material be taken up together with interleaving paper, e.g., paper, or a film of polyethylene, polypropylene, or polyester, and a polypropylene film or a polyester film having a thickness of 25 μm or less is preferable.

[Adhesive Layer]

The adhesive layer used for the adhesive tape according to the present invention has a thickness of 50 μm or less, preferably 10 to 40 μm, and more preferably 10 to 30 μm. The thickness of the adhesive layer is specified to be the above-described range and, thereby, at the time of rework of a rigid member, a local stress is not applied to the rigid member easily, cracking, breakage, distortion of the rigid member do not occur easily, and favorable reworkability can be realized.

Meanwhile, as for the adhesion force of the adhesive layer, the 180° peel adhesion force is 0.3 to 4 N/20 mm, preferably 0.4 to 3 N/20 mm, more preferably 0.5 to 2.5 N/20 mm, and particularly preferably 0.8 to 2 N/20 mm at a peel rate of 300 mm/min, where the adhesive tape, which is formed by disposing the adhesive layer having a thickness of 25 μm on a PET base material having a thickness of 25 μm, is press-bonded to a SUS sheet in an environment at a temperature of 23° C. and a relative humidity of 50% RH by using a 2-kg roller with the number of press bonding cycles of one reciprocating motion and standing is performed for 1 hour in an environment at a temperature of 23° C. and a relative humidity of 50% RH. The adhesion force is specified to be the above-described range and, thereby, cracking, breakage, and distortion of the rigid member do not occur easily at the time of rework, and favorable impact resistance can be realized.

It is preferable that the temperature, at which the loss tangent (tan δ) at a frequency of 1 Hz of the adhesive layer used for the adhesive tape according to the present invention exhibits a peak value, be a temperature of preferably −50° C. to 15° C. The peak value of the loss tangent of the adhesive layer is specified to be within the above-described range and, thereby, good adhesiveness to an adherend at ambient temperature is provided easily. In particular, on the occasion of improvement in the drop impact resistance in a low-temperature environment, −45° C. to −10° C. is more preferable, and −40° C. to 6° C. is further preferable.

The loss tangent (tan δ) at a frequency of 1 Hz is determined from the storage modulus (G′) and the loss modulus (G″) obtained by a measurement of temperature variance of dynamic viscoelasticity on the basis of the formula tan δ=G″/G′. In the measurement of dynamic viscoelasticity, a viscoelasticity tester (trade name: ARES G2, produced by TA Instruments Japan, Inc.) is used, a test specimen of an adhesive layer formed having a thickness of about 2 mm is sandwiched between parallel discs having a diameter of 8 mm and serving as the measurement portion of the above-described tester, and the storage modulus (G′) and the loss modulus (G″) are measured at −60° C. to 150° C. and a frequency of 1 Hz.

The tensile elongation at break in a tensile test of the adhesive layer is not specifically limited, although the tensile elongation in the flow direction is preferably 200% to 600%, and more preferably 250% to 550%. In the case where the tensile elongation of the adhesive layer is within the above-described range, favorable reworkability is realized easily.

In this regard, the tensile elongation at break in the tensile test of the adhesive layer is the elongation at the time when Tensilon tensile tester is used and a sample with a gauge length of 2 cm and a width of 1 cm is pulled and cut in an environment at 23° C. and 50% RH under the measurement condition of a pulling rate of 300 mm/min.

Adhesive compositions used for common adhesive tapes can be used as the adhesive composition constituting the adhesive layer of the adhesive tape according to the present invention. Examples of the adhesive compositions include (meth)acrylic adhesives, urethane based adhesives, synthetic rubber based adhesives, natural rubber based adhesives, and silicone based adhesives. The (meth)acrylic adhesive compositions can be used favorably, where a base polymer is made from a (meth)acrylate alone or is an acrylic copolymer which is a copolymer of an (meth)acrylate and other monomers and, as necessary, adhesives, e.g., a tackifier resin and a cross-linking agent, are blended therewith.

As for the acrylic copolymers, preferably, acrylic copolymers, in which a primary monomer component is a (meth)acrylate monomer having the carbon number of 1 to 12, can be used. Examples of (meth)acrylates having the carbon number of 1 to 12 include monomers, e.g., methyl (meth)acrylate, ethyl (meth)acrylate, n-butyl (meth)acrylate, isobutyl (meth)acrylate, t-butyl (meth)acrylate, n-hexyl (meth)acrylate, n-octyl (meth)acrylate, isooctyl (meth)acrylate, isononyl (meth)acrylate, cyclohexyl (meth)acrylate, and 2-ethylhexyl (meth)acrylate. At least one type of them is used. Among them, (meth)acrylates having the carbon number of alkyl group of 4 to 12 are preferable, and (meth)acrylates including a straight chain or branched structure having the carbon number of 4 to 9 are further preferable. Most of all, acrylates including a straight chain or branched structure having the carbon number of 4 to 9 are further preferable.

The content of (meth)acrylate having the carbon number of 1 to 12 in the acrylic copolymer is preferably 80 to 98.5 percent by mass in the monomer components constituting the acrylic copolymer, and more preferably 90 to 98.5 percent by mass.

Also, in the acrylic copolymer used for the present invention, a highly polar vinyl monomer may be copolymerized. Examples of highly polar vinyl monomers include vinyl monomers having a hydroxyl group, vinyl monomers having a carboxyl group, and vinyl monomers having an amide group. At least one type of them is used.

As for the monomer having a hydroxyl group, for example, hydroxy-containing (meth)acrylates, e.g., 2-hydroxyethyl (meth)acrylate, 2-hydroxypropyl (meth)acrylate, 4-hydroxybutyl (meth)acrylate, and 6-hydroxyhexyl (meth)acrylate, can be used.

As for the vinyl monomer having a carboxyl group, acrylic acid, (meth)acrylic acid, itaconic acid, maleic acid, (meth)acrylic acid dimer, crotonic acid, ethylene oxide-modified succinic acid acrylate, and the like can be used. Among them, it is preferable that acrylic acid be used as a copolymer component.

Also, examples of monomers having an amide group include N-vinylpyrrolidone, N-vinylcaprolactam, acryloylmorpholine, acrylamide, and N,N-dimethylacrylamide.

Examples of other highly polar vinyl monomers include vinyl acetate, ethylene oxide-modified succinic acid acrylate, sulfonic-containing monomers, e.g., 2-acrylamide-2-methylpropanesulfonic acid, and terminal-alkoxy-modified (meth)acrylates, e.g., 2-methoxyethyl (meth)acrylate and 2-phenoxyethyl (meth)acrylate.

The content of the highly polar vinyl monomer is preferably 0.2 to 15 percent by mass in the monomer components constituting the acrylic copolymer, more preferably 0.4 to 10 percent by mass, and further preferably 0.5 to 6 percent by mass. In the case where the content is within the above-described range, the cohesive force, holding power, and the adhesion properties of the adhesive are adjusted within favorable ranges easily.

Meanwhile, in the case where an isocyanate based cross-linking agent is used as the cross-linking agent, a hydroxyl-containing vinyl monomer is preferable as the vinyl monomer having a functional group which reacts with the cross-linking agent, and 2-hydroxyethyl (meth)acrylate, 4-hydroxybutyl (meth)acrylate, and 6-hydroxyhexyl (meth)acrylate are particularly preferable. The content of the hydroxyl-containing vinyl monomer which reacts with the isocyanate based cross-linking agent is preferably 0.1 to 5.0 percent by mass in the monomer components constituting the acrylic copolymer, and particularly preferably 0.1 to 2.5 percent by mass.

The acrylic copolymer can be obtained by performing copolymerization on the basis of a known polymerization method, e.g., a solution polymerization method, a bulk polymerization method, a suspension polymerization method, and an emulsion polymerization method, the solution polymerization method and the bulk polymerization method are preferable from the viewpoint of the water resistance of the adhesive. As for a method for initiating the polymerization, a thermal initiation method in which a peroxide based thermal polymerization initiator, e.g., benzoyl peroxide or lauroyl peroxide, or an azo based thermal polymerization initiator, e.g., azobisisobutyronitrile, is used, an ultraviolet irradiation initiation method in which an acetophenone based, benzoin ether based, benzyl ketal based, acylphosphine oxide based, benzoin based, or benzophenone based photopolymerization initiator is used, or a method by electron beam irradiation is selected optionally.

As for the molecular weight of the above-described acrylic copolymer, the weight average molecular weight measured by gel permeation chromatograph (GPC) is 40 to 3,000,000, and preferably 80 to 2,500,000 in terms of standard polystyrene.

Here, in the measurement of the molecular weight by the GPC method, a value in terms of standard polystyrene is measured by using a GPC system (HLC-8329GPC) produced by Tosoh Corporation and the measurement condition is as described below.

Sample concentration: 0.5 percent by mass (THF solution)

Amount of sample injection: 100 μl

Eluent: THF

Flow rate: 1.0 ml/min

Measurement temperature: 40° C.

Main column: TSKgel GMHHR-H(20) 2 units

Guard column: TSKgel: HXL-H

Detector: differential refractometer

Standard polystyrene molecular weight: 10,000 to 20,000,000 (produced by Tosoh Corporation)

In order to improve the adhesiveness to an adherend and adhesion force, a tackifier resin may be used in the acrylic adhesive composition used for the present invention. Examples of tackifier resins include rosin based, polymerized rosin based, polymerized rosin ester based, rosin phenol based, stabilized rosin ester based, disproportionated rosin ester based, hydrogenated rosin ester based, terpene based, terpene phenol based, petroleum resin based, and (meth)acrylate based resins. In the case of use for the emulsion type adhesive composition, it is preferable that an emulsion type tackifier resin be used.

In the acrylic adhesive composition, in order to enhance the cohesive force of the adhesive layer, it is preferable to cross-link the adhesive. Examples of such cross-linking agents include isocyanate based cross-linking agents, epoxy based cross-linking agents, metal chelate based cross-linking agents, and aziridine based cross-linking agents. Among them, cross-linking agents of the type which is added after completion of the polymerization and which facilitates a cross-linking reaction are preferable, so that isocyanate based cross-linking agents and epoxy based cross-linking agents reactive with (meth)acrylic copolymers are preferable, and isocyanate based cross-linking agents are more preferable because adhesiveness to the foam base material is improved.

Examples of isocyanate based cross-linking agents include tolylene diisocyanate, naphthylene-1,5-diisocyanate, hexamethylene diisocyanate, diphenylmethane diisocyanate, xylylene diisocyanate, and trimethylolpropane-modified tolylene diisocyanate. Trifunctional polyisocyanate based compounds are particularly preferable. Examples of trifunctional isocyanate based compounds include tolylene diisocyanate, trimethylolpropane adducts thereof, and triphenylmethane isocyanate.

In the case where an index of the degree of cross-linking, which is the value of gel fraction on the basis of measurement of insoluble matters after the adhesive layer is immersed in toluene for 24 hours, is within the range of 70 to 95 percent by mass, and further preferably 80 to 93 percent by mass, both the cohersiveness and the adhesion properties are good.

In this regard, the gel fraction is measured as described below. An adhesive composition is applied to a release sheet in such a way that the thickness after drying becomes 50 μm, drying is performed at 100° C. for 3 minutes, aging is performed at 40° C. for 2 days, and cutting into 50 mm square is performed to prepare a sample. Subsequently, the weight (G1) of the above-described sample before immersion in toluene is measured in advance. Toluene-insoluble matters in the sample after immersion in toluene at 23° C. for 24 hours are separated by filtration with a 300-mesh wire gauge, drying is performed at 110° C. for 1 hour and, thereafter, the weight (G2) of the residue is measured. The gel fraction is determined on the basis of the following formula.

gel fraction (percent by mass)=(G2/G1)×100

As for additives of the adhesive, as necessary, known materials, for example, a plasticizer, a softener, an antioxidant, a flame retarder, a filler, e.g., glass or plastic fibers•balloons•beeds, a metal powder, a metal oxide, or a metal nitride, a colorant, e.g., pigment•dye, a leveling agent, a thickener, a water-repellent agent, and an antifoamer can be added to the adhesive composition optionally.

The adhesive tape according to the present invention is an adhesive tape including the above-described adhesive layer on at least one surface. In the case where the adhesive tape according to the present invention is specified to be a double-faced adhesive tape, as described later, one adhesive layer is specified to be the above-described low-adhesion adhesive layer, and the other surface is specified to be a high-adhesion adhesive layer having an adhesion force higher than the adhesion force of the low-adhesion adhesive layer, the following adhesive layer can be favorably used as the high-adhesion adhesive layer.

The thickness of the high-adhesion adhesive layer is preferably 50 μm or less, more preferably 10 to 40 μm, and further preferably 10 to 30 μm, which is the same as the thickness of the low-adhesion adhesive layer, because favorable reworkability is ensured easily.

Meanwhile, as for the adhesion force of the high-adhesion adhesive layer, the 180° peel adhesion force of the adhesive layer is preferably 1 to 25 N/20 mm, and more preferably 1.5 to 20 N/20 mm at a peel rate of 300 mm/min, where the adhesive tape, which is formed by disposing the adhesive layer having a thickness of 25 μm on a PET base material having a thickness of 25 μm, is press-bonded to a SUS sheet in an environment at a temperature of 23° C. and a relative humidity of 50% RH by using a 2-kg roller with the number of press bonding cycles of one reciprocating motion and standing is performed for 1 hour in an environment at a temperature of 23° C. and a relative humidity of 50% RH. Also, it is preferable that the 180° peel adhesion force of the high-adhesion adhesive layer is specified to be an adhesion force larger than the 180° peel adhesion force of the low-adhesion adhesive layer by 1 N/20 mm or more, preferably 5 to 20 N/20 mm, and more preferably 8 to 15 N/20 mm because more selective peeling is performed easily.

It is preferable that the temperature, at which the loss tangent (tan δ) at a frequency of 1 Hz of the high-adhesion adhesive layer exhibits a peak value, be a temperature of preferably −40° C. to 15° C. The peak value of the loss tangent of the adhesive layer is specified to be within the above-described range and, thereby, good adhesiveness to an adherend at ambient temperature is provided easily. In particular, on the occasion of improvement in the drop impact resistance in a low-temperature environment, −35° C. to 10° C. is more preferable, and −30° C. to 6° C. is further preferable.

As for the adhesive composition constituting the high-adhesion adhesive layer, the same adhesive composition as that of the above-described low-adhesion adhesive layer used for a common adhesive tape can be used insofar as the adhesion force is within the above-described range. Among them, the (meth)acrylic adhesive composition can be used favorably.

As for the acrylic copolymers, preferably, acrylic copolymers, in which a primary monomer component is a (meth)acrylate monomer having the carbon number of 1 to 12, can be used. At least one type of monomer, which is the same monomer as the monomer of the above-described low-adhesion adhesive layer, is used as the (meth)acrylate having the carbon number of 1 to 12. Among them, (meth)acrylates having the carbon number of alkyl group of 4 to 12 are preferable, and (meth)acrylates including a straight chain or branched structure having the carbon number of 4 to 8 are further preferable. In particular, n-butyl acrylate is preferable because the adhesiveness to an adherend is ensured easily, and the cohesive force and the resistance against various types of sebum are excellent.

The content of (meth)acrylate having the carbon number of 1 to 12 in the acrylic copolymer is preferably 80 to 98.5 percent by mass in the monomer components constituting the acrylic copolymer, and more preferably 90 to 98.5 percent by mass.

Also, in the acrylic copolymer used for the high-adhesion adhesive layer, a highly polar vinyl monomer may be copolymerized. Examples of highly polar vinyl monomers include vinyl monomers having a hydroxyl group, vinyl monomers having a carboxyl group, and vinyl monomers having an amide group. At least one type of them is used. The same monomers as the monomers of the above-described low-adhesion adhesive layer are used as these highly polar vinyl monomers and vinyl monomers having a carboxyl group, in particular acrylic acid, can be used favorably.

The content of the highly polar vinyl monomer is preferably 1.5 to 20 percent by mass in the monomer components constituting the acrylic copolymer, more preferably 1.5 to 10 percent by mass, and further preferably 2 to 8 percent by mass. In the case where the content is within the above-described range, the cohesive force, holding power, and the adhesion properties of the adhesive are adjusted within favorable ranges easily.

Meanwhile, in the case where an isocyanate based cross-linking agent is used as the cross-linking agent, a hydroxyl-containing vinyl monomer is preferable as the vinyl monomer having a functional group which reacts with the cross-linking agent, and 2-hydroxyethyl (meth)acrylate, 4-hydroxybutyl (meth)acrylate, and 6-hydroxyhexyl (meth)acrylate are particularly preferable. The content of the hydroxyl-containing vinyl monomer which reacts with the isocyanate based cross-linking agent is preferably 0.01 to 1.0 percent by mass in the monomer components constituting the acrylic copolymer, and particularly preferably 0.03 to 0.3 percent by mass.

As for the molecular weight of the above-described acrylic copolymer, the weight average molecular weight measured by gel permeation chromatograph (GPC) is 40 to 3,000,000, and preferably 80 to 2,500,000 in terms of standard polystyrene. The measurement of the molecular weight by the GPC method is performed in the same manner as the measurement of the above-described low-adhesion adhesive layer.

In order to improve the adhesiveness to an adherend and the surface adhesive strength, preferably, a tackifier resin is used in the acrylic adhesive composition used for the high-adhesion adhesive layer. Examples of tackifier resins can include rosin based, polymerized rosin based, polymerized rosin ester based, rosin phenol based, stabilized rosin ester based, disproportionated rosin ester based, hydrogenated rosin ester based, terpene based, terpene phenol based, petroleum resin based, and (meth)acrylate based resins. In the case of use for the emulsion type adhesive composition, it is preferable that an emulsion type tackifier resin be used.

Among them, disproportionated rosin ester based tackifier resins, polymerized rosin ester based tackifier resins, rosin phenol based tackifier resins, hydrogenated rosin ester based tackifier resins, and (meth)acrylate based resins are preferable. At least one type of tackifier resin may be used.

The softening point of the tackifier resin is not specifically limited but is 30° C. to 180° C., and preferably 70° C. to 140° C. High adhesion performance can be expected by blending the tackifier resin having a high softening point. In the case of a (meth)acrylate based tackifier resin, the glass transition point is 30° C. to 200° C., and preferably 50° C. to 160° C.

As for the blend ratio when the acrylic copolymer and the tackifier resin are used, the content of the tackifier resin relative to 100 parts by mass of the acrylic copolymer is preferably 5 to 60 parts by mass, and preferably 8 to 50 parts by mass. In the case where the ratio of the two is specified to be within the above-described range, the adhesiveness to an adherend is ensured easily.

In the acrylic adhesive composition, in order to enhance the cohesive force of the adhesive layer, it is preferable to cross-link the adhesive. The same cross-linking agents as those of the above-described low-adhesion adhesive layer can be used as such a cross-linking agent. Among them, cross-linking agents of the type which is added after completion of the polymerization and which facilitates a cross-linking reaction are preferable, so that isocyanate based cross-linking agents and epoxy based cross-linking agents reactive with (meth)acrylic copolymers are preferable, and isocyanate based cross-linking agents are more preferable because adhesiveness to the foam base material is improved. Examples of isocyanate based cross-linking agents include the same cross-linking agents as those of the above-described low-adhesion adhesive layer.

As for an index of the degree of cross-linking, the value of gel fraction on the basis of measurement of insoluble matters after the adhesive layer is immersed in toluene for 24 hours is used. The gel fraction is preferably 25 to 70 percent by mass. Both the cohersiveness and the adhesion properties are good in the case where the gel fraction is within the range of more preferably 30 to 60 percent by mass, and further preferably 30 to 55 percent by mass.

As with the low-adhesion adhesive layer, as necessary, known additives, for example, a plasticizer, a softener, an antioxidant, a flame retarder, a filler, e.g., glass or plastic fibers•balloons•beeds, a metal powder, a metal oxide, or a metal nitride, a colorant, e.g., pigment•dye, a leveling agent, a thickener, a water-repellent agent, and an antifoamer can be added to the adhesive composition optionally.

[Adhesive Tape]

The adhesive tape according to the present invention includes the above-described adhesive layer on at least one surface, preferably both surfaces, of the above-described foam base material and, therefore, exhibits favorable impact resistance and good reworkability of the rigid member. Consequently, the adhesive tape can be favorably applied to fixing of protective panels of image display portions of portable electronic devices, e.g., smart phones and tablet type personal computers, and image display modules, e.g., liquid crystal display modules and organic EL modules provided with a glass on a surface layer portion. Also, the adhesive tape exhibits excellent adhesion properties between rigid members and, therefore, can be favorably applied to bonding of a protective panel and an image display module and fixing of an image display module to a casing or support with a tabular bonding portion.

In an embodiment of the adhesive tape according to the present invention, the basic configuration is a configuration in which the foam base material serves as a center core, and the adhesive layer is disposed on at least one surface, preferably both surfaces, of the base material. The base material and the adhesive layer may be stacked directly, or another layer may be included therebetween. These aspects may be selected appropriately in accordance with the use application. A laminate layer, e.g., a polyester film, may be disposed in the case where the dimension stability and the tensile strength are further given to the tape, a light shielding layer may be disposed in the case where the light shielding property is given to the tape, and a light reflection layer may be disposed when the light reflection property is ensured. In the cases where the other layer is disposed, a water-resistant layer is used as the other layer.

At the time of fixing of at least two members, in the case of a form of single-faced adhesive tape, one member to be fixed may be bonded to the other member with another adhesive tape or adhesive therebetween. However, in the case of a form of double-faced adhesive tape, favorably, fixing between the members becomes easy. In the case where the double-faced adhesive tape is employed, the adhesive layers on both surfaces may be low-adhesion adhesive layers having a 180° peel adhesion force of 0.3 to 4 N/20 mm, although it is preferable that one surface is specified to be a low-adhesion adhesive layer and the other surface is specified to be a high-adhesion adhesive layer having an adhesion force larger than the adhesion force of the low-adhesion adhesive layer because peeling is performed from the predetermined member side easily at the time of peeling.

Various resin films including polyester films of polyethylene terephthalate and the like, polyethylene films, and polypropylene films can be used as the laminate layer. The thicknesses thereof are preferably 1 to 16 μm, and more preferably 2 to 12 μm from the viewpoint of the conformability of the foam base material.

As for the light shielding layer, layers formed from inks containing colorants, e.g., pigments, are used simply, and a layer formed from a black ink is used preferably because of excellent light shielding property. As for the reflection layer, a layer formed from a white ink can be used simply. The thicknesses thereof are preferably 2 to 20 μm, and most of all, 4 to 6 μm is more preferable. The thicknesses are specified to be within the above-described ranges and, thereby, curling of the base material due to cure shrinkage of the ink does not occur easily and the workability of the tape becomes good.

The adhesive tape according to the present invention can be produced by a known common method. For example, a direct coating method, in which the adhesive composition is applied to the foam base material directly or the surface of the other layer stacked on the foam base material and drying is performed, and a transfer coating method, in which the adhesive composition is applied to a release sheet, drying is performed and, thereafter, bonding to the foam base material or the other layer surface is performed, are mentioned. In this regard, in the case where the adhesive layer is produced by drying the blend of the acrylic adhesive composition and the cross-linking agent, it is preferable that aging be performed in an environment at 20° C. to 50° C., and preferably 23° C. to 45° C. for 2 to 7 days after the adhesive tape is formed because the adhesiveness between the foam base material and the adhesive layer and the adhesive properties are stabilized.

The thickness of the adhesive tape according to the present invention may be adjusted appropriately in accordance with the aspect of the use, although 500 μm or less is preferable, 100 to 400 μm is more preferable, 120 to 350 μm is further preferable, and 130 to 250 μm is particularly preferable for fixing the components of small, thin portable electronic devices. The tape thickness is specified to be the above-described thickness, so that the adhesive tape can be favorably applied to a thing small portable electronic device and good conformability and impact resistance and, in addition, favorable reworkability can be realized.

As for the adhesive tape according to the present invention, the 180° peel adhesion force is preferably 0.2 to 6 N/20 mm, and more preferably 0.5 to 5 N/20 mm at a peel rate of 300 mm/min, where the adhesive tape is press-bonded to a glass sheet in an environment at a temperature of 23° C. and a relative humidity of 50% RH by using a 2-kg roller with the number of press bonding cycles of one reciprocating motion and standing is performed for 1 hour in an environment at a temperature of 23° C. and a relative humidity of 50% RH. Meanwhile, in the case where the adhesive tape is specified to be a double-faced adhesive tape including the low-adhesion adhesive layer and the high-adhesion adhesive layer, it is preferable that the adhesion force at the time of bonding of the low-adhesion adhesive layer to the glass sheet be within the above-described range.

The release sheet used for the present invention is not specifically limited. Examples thereof include base materials, for example, synthetic resin films, e.g., polyethylenes, polypropylenes, and polyester films, paper, nonwoven fabrics, cloths, foam sheets, metal foil, and laminates thereof, in which at least one surface thereof has been subjected to a release treatment, e.g., a silicone based treatment, a long chain alkyl based treatment, or a fluorine based treatment, to enhance the releasability from the adhesive.

Among them, release sheets, in which one surface or both surfaces of base material, e.g., premium grade paper with laminated polyethylene having a thickness of 10 to 40 μm on both sides and polyester films, have been subjected to the silicone based release treatment, are preferable.

The adhesive tape according to the present invention exhibits excellent impact resistance and, in addition, excellent reworkability in spite of small thickness at the time of fixing of a tabular rigid member. Also, tabular rigid bodies can be fixed to each other. Consequently, the adhesive tape can favorably fix a thin tabular rigid body, in which crack and distortion occur easily, for example, a tabular rigid body of glass, plastics, or metal having a thickness of 5 mm or less, preferably 3 mm or less, and particularly preferably 1 mm or less, and exhibits favorable reworkability, where crack and distortion does not occur easily in the tabular rigid body at the time of rework.

The adhesive tape according to the present invention has such excellent characteristics and, therefore, can be favorably applied to portable electronic devices, e.g., electronic notebooks, cellular phones, PHS phones, digital cameras, music players, televisions, notebook type personal computers, smart phones, tablet type personal computers, and game machines, and electronic devices, e.g., wall-mounted type televisions, monitors, and personal computers. In particular, the adhesive tape can be favorably applied to fixing of a protective panel to protect an information display device, e.g., a LCD or an organic EL display, in which crack and distortion occur easily, or thin tabular rigid body, e.g., a LCD module or an organic EL module, provided with glass on the surface layer. Also, the adhesive tape is suitable for fixing these members to each other or fixing these members to casings or supports with a tabular bonding portion.

### EXAMPLES

### Preparation of Adhesive Solution (A)

In a reaction vessel provided with an agitator, a reflux condenser, a thermometer, a dropping funnel, and a nitrogen gas inlet, Acrylic copolymer (1) having a weight average molecular weight of 2,020,000 (in terms of polystyrene) was obtained by dissolving 88 parts by mass of 2-ethylhexyl acrylate, 8 parts by mass of 2-methoxyethyl acrylate, 1 part by mass of acrylic acid, 3 parts by mass of 4-hydroxybutyl acrylate, and 0.1 parts by mass of 2,2′-azobisisobutyronitrile serving as a polymerization initiator into a solvent composed of 150 parts by mass of ethyl acetate and inducing polymerization at 70° C. for 12 hours. Subsequently, ethyl acetate was added and mixing was performed uniformly, so that Adhesive solution (A) having a nonvolatile content of 30% was obtained.

### Preparation of Adhesive Solution (B)

In a reaction vessel provided with an agitator, a reflux condenser, a thermometer, a dropping funnel, and a nitrogen gas inlet, Acrylic copolymer (2) having a weight average molecular weight of 1,970,000 (in terms of polystyrene) was obtained by dissolving 88.6 parts by mass of 2-ethylhexyl acrylate, 10 parts by mass of methyl acrylate, 1 part by mass of acrylic acid, 0.4 parts by mass of 4-hydroxybutyl acrylate, and 0.1 parts by mass of 2,2′-azobisisobutyronitrile serving as a polymerization initiator into a solvent composed of 150 parts by mass of ethyl acetate and inducing polymerization at 70° C. for 12 hours. Subsequently, ethyl acetate was added and mixing was performed uniformly, so that Adhesive solution (B) having a nonvolatile content of 30% was obtained.

### Preparation of Adhesive Solution (C)

In a reaction vessel provided with an agitator, a reflux condenser, a thermometer, a dropping funnel, and a nitrogen gas inlet, Acrylic copolymer (3) having a weight average molecular weight of 1,700,000 (in terms of polystyrene) was obtained by dissolving 83.6 parts by mass of 2-ethylhexyl acrylate, 15 parts by mass of methyl acrylate, 1 part by mass of acrylic acid, 0.4 parts by mass of 4-hydroxybutyl acrylate, and 0.1 parts by mass of 2,2′-azobisisobutyronitrile serving as a polymerization initiator into a solvent composed of 150 parts by mass of ethyl acetate and inducing polymerization at 70° C. for 12 hours. Subsequently, ethyl acetate was added and mixing was performed uniformly, so that Adhesive solution (C) having a nonvolatile content of 30% was obtained.

### Preparation of Adhesive Solution (D)

In a reaction vessel provided with an agitator, a reflux condenser, a thermometer, a dropping funnel, and a nitrogen gas inlet, Acrylic copolymer (3) having a weight average molecular weight of 1,380,000 (in terms of polystyrene) was obtained by dissolving 73 parts by mass of 2-ethylhexyl acrylate, 25 parts by mass of methyl acrylate, 1 part by mass of acrylic acid, 1 part by mass of 2-hydroxyethyl acrylate, and 0.1 parts by mass of 2,2′-azobisisobutyronitrile serving as a polymerization initiator into a solvent composed of 150 parts by mass of ethyl acetate and inducing polymerization at 70° C. for 12 hours. Subsequently, ethyl acetate was added and mixing was performed uniformly, so that Adhesive solution (D) having a nonvolatile content of 30% was obtained.

### Preparation of Adhesive Solution (E)

In a reaction vessel provided with an agitator, a reflux condenser, a thermometer, a dropping funnel, and a nitrogen gas inlet, Acrylic copolymer (1) having a weight average molecular weight of 1,600,000 (in terms of polystyrene) was obtained by dissolving 93.4 parts by mass of n-butyl acrylate, 3.5 parts by mass of acrylic acid, 3 parts by mass of vinyl acetate, 0.1 parts by mass of 2-hydroxyethyl acrylate, and 0.1 parts by mass of 2,2′-azobisisobutyronitrile serving as a polymerization initiator into a solvent composed of 100 parts by mass of ethyl acetate and inducing polymerization at 70° C. for 12 hours. Subsequently, 9.4 parts by mass of “SUPER ESTER A-100” (glycerin ester of disproportionated rosin) produced by ARAKAWA CHEMICAL INDUSTRIES LTD., and 9.4 parts by mass of “HARITACK PCJ” (pentaerythritol ester of polymerized rosin) produced by Harima Chemicals, Inc., relative to 100 parts by mass of Acrylic copolymer (1) were added, ethyl acetate was added, and mixing was performed uniformly, so that Adhesive solution (E) having a nonvolatile content of 38% was obtained.

### Preparation of Adhesive Solution (F)

In a reaction vessel provided with an agitator, a reflux condenser, a thermometer, a dropping funnel, and a nitrogen gas inlet, Acrylic copolymer (2) having a weight average molecular weight of 1,200,000 (in terms of polystyrene) was obtained by dissolving 74.9 parts by mass of n-butyl acrylate, 20 parts by mass of 2-ethylhexyl acrylate, 2.0 parts by mass of acrylic acid, 3 parts by mass of vinyl acetate, 0.1 parts by mass of 4-hydroxybutyl acrylate, and 0.1 parts by mass of 2,2′-azobisisobutyronitrile serving as a polymerization initiator into a solvent composed of 100 parts by mass of ethyl acetate and inducing polymerization at 70° C. for 12 hours. Subsequently, 20 parts by mass of “PENSEL D-135” (pentaerythritol ester of polymerized rosin) produced by ARAKAWA CHEMICAL INDUSTRIES LTD., relative to 100 parts by mass of Acrylic copolymer (2) was added, ethyl acetate was added, and mixing was performed uniformly, so that Adhesive solution (F) having a nonvolatile content of 50% was obtained.

### Preparation of Adhesive Solution (G)

In a reaction vessel provided with an agitator, a reflux condenser, a thermometer, a dropping funnel, and a nitrogen gas inlet, Acrylic copolymer (2) having a weight average molecular weight of 1,600,000 (in terms of polystyrene) was obtained by dissolving 97.97 parts by mass of n-butyl acrylate, 2.0 parts by mass of acrylic acid, 0.03 parts by mass of 4-hydroxybutyl acrylate, and 0.1 parts by mass of 2,2′-azobisisobutyronitrile serving as a polymerization initiator into a solvent composed of 100 parts by mass of ethyl acetate and inducing polymerization at 70° C. for 12 hours. Subsequently, 25 parts by mass of “SUPER ESTER A-100” (glycerin ester of disproportionated rosin) produced by ARAKAWA CHEMICAL INDUSTRIES LTD., 5 parts by mass of “PENSEL D-135” (pentaerythritol ester of polymerized rosin) produced by ARAKAWA CHEMICAL INDUSTRIES LTD., and 20 parts by mass of FTR6100 (styrene based petroleum resin) produced by Mitsui Chemicals, Inc., relative to 100 parts by mass of Acrylic copolymer (2) were added, ethyl acetate was added, and mixing was performed uniformly, so that Adhesive solution (G) having a nonvolatile content of 40% was obtained.

### Example 1

### Preparation of Double-Faced Adhesive Tape

A low-adhesion adhesive layer was formed by adding 0.89 parts by mass of “Coronate L-45” (isocyanate based cross-linking agent, solid content 45%) produced by NIPPON POLYURETHANE INDUSTRY CO., LTD., relative to 100 parts by mass of Adhesive composition (A) described above, performing agitation for 15 minutes, applying the resulting mixture to a release-treated surface of a release-treated PET film having a thickness of 75 μm in such a way that the thickness after drying became 20 μm, and performing drying at 80° C. for 3 minutes. The gel fraction of the low-adhesion adhesive layer was 87 percent by mass and the temperature, at which the loss tangent (tan δ) at a frequency of 1 Hz exhibited a peak value, was −38° C.

Subsequently, a high-adhesion adhesive layer (e) was formed by adding 1.1 parts by mass of “Coronate L-45” (isocyanate based cross-linking agent, solid content 45%) produced by NIPPON POLYURETHANE INDUSTRY CO., LTD., relative to 100 parts by mass of Adhesive composition (E) described above, performing agitation for 15 minutes, applying the resulting mixture to a release-treated surface of a release-treated PET film having a thickness of 75 μm in such a way that the thickness after drying became 25 μm, and performing drying at 80° C. for 3 minutes. The gel fraction of the adhesive layer (e) was 48 percent by mass and the temperature, at which the loss tangent (tan δ) at a frequency of 1 Hz exhibited a peak value, was −16° C.

Then, one sheet of the above-described low-adhesion adhesive layer was bonded to one surface of a base material formed from Black polyolefin based foam (1) (thickness: 100 μm, interlaminar strength: 12.6 N/cm, apparent density: 0.40 g/cm³, 25% compressive strength: 103 kPa, tensile strength in the flow direction: 1,084 N/cm², tensile strength in the width direction: 790 N/cm², surface was corona-treated to exhibit the wetting index of 52 mN/m, produced by Sekisui Chemical Co., Ltd.) and one sheet of the high-adhesion adhesive layer was bonded to the opposite surface. Thereafter, lamination was performed with a roll at 23° C. and a linear pressure of 5 kg/cm. Subsequently, aging was performed at 40° C. for 48 hours, so that a double-faced adhesive tape having a thickness of 145 μm was obtained.

### Example 2

A double-faced adhesive tape having a thickness of 145 μm was obtained in the same manner as in Example 1 except that Adhesive composition (B) was used instead of Adhesive composition (A) and a mixture, in which 0.67 parts by mass of “Coronate L-45” (isocyanate based cross-linking agent, solid content 45%) produced by NIPPON POLYURETHANE INDUSTRY CO., LTD., was added relative to 100 parts by mass of Adhesive composition (B), was used for the low-adhesion adhesive layer. The gel fraction of the low-adhesion adhesive layer was 86 percent by mass and the temperature, at which the loss tangent (tan δ) at a frequency of 1 Hz exhibited a peak value, was −36° C.

### Example 3

A double-faced adhesive tape having a thickness of 145 μm was obtained in the same manner as in Example 1 except that Adhesive composition (C) was used instead of Adhesive composition (A) and a mixture, in which 0.89 parts by mass of “Coronate L-45” (isocyanate based cross-linking agent, solid content 45%) produced by NIPPON POLYURETHANE INDUSTRY CO., LTD., was added relative to 100 parts by mass of Adhesive composition (C), was used for the low-adhesion adhesive layer. The gel fraction of the adhesive layer was 90 percent by mass and the temperature, at which the loss tangent (tan δ) at a frequency of 1 Hz exhibited a peak value, was −31° C.

### Example 4

A double-faced adhesive tape having a thickness of 145 μm was obtained in the same manner as in Example 1 except that Adhesive composition (B) was used instead of Adhesive composition (A) and a mixture, in which 0.34 parts by mass of “Coronate L-45” (isocyanate based cross-linking agent, solid content 45%) produced by NIPPON POLYURETHANE INDUSTRY CO., LTD., was added relative to 100 parts by mass of Adhesive composition (B), was used for the low-adhesion adhesive layer. The gel fraction of the adhesive layer was 81 percent by mass and the temperature, at which the loss tangent (tan δ) at a frequency of 1 Hz exhibited a peak value, was −37° C.

### Example 5

A double-faced adhesive tape having a thickness of 145 μm was obtained in the same manner as in Example 1 except that Adhesive composition (D) was used instead of Adhesive composition (A) and a mixture, in which 1.33 parts by mass of “Coronate L-45” (isocyanate based cross-linking agent, solid content 45%) produced by NIPPON POLYURETHANE INDUSTRY CO., LTD., was added relative to 100 parts by mass of Adhesive composition (D), was used for the low-adhesion adhesive layer. The gel fraction of the adhesive layer was 87 percent by mass and the temperature, at which the loss tangent (tan δ) at a frequency of 1 Hz exhibited a peak value, was −25° C.

### Example 6

A double-faced adhesive tape having a thickness of 145 μm was obtained in the same manner as in Example 3 except that Black polyolefin based foam (2) (thickness: 100 μm, interlaminar strength: 8.9 N/cm, apparent density: 0.33 g/cm³, 25% compressive strength: 70 kPa, tensile strength in the flow direction: 799 N/cm², tensile modulus in the width direction: 627 N/cm², surface was corona-treated to exhibit the wetting index of 52 mN/m, produced by Sekisui Chemical Co., Ltd.) was used instead of Black polyolefin based foam (1).

### Example 7

A double-faced adhesive tape having a thickness of 185 μm was obtained in the same manner as in Example 3 except that Black polyolefin based foam (3) (thickness: 140 μm, interlaminar strength: 19.1 N/cm, apparent density: 0.40 g/cm³, 25% compressive strength: 130 kPa, tensile strength in the flow direction: 994 N/cm², tensile modulus in the width direction: 713 N/cm², surface was corona-treated to exhibit the wetting index of 52 mN/m, produced by Sekisui Chemical Co., Ltd.) was used instead of Black polyolefin based foam (1).

### Example 8

A double-faced adhesive tape having a thickness of 245 μm was obtained in the same manner as in Example 3 except that Black polyolefin based foam (4) (thickness: 200 μm, interlaminar strength: 12.9 N/cm, apparent density: 0.20 g/cm³, 25% compressive strength: 52 kPa, tensile strength in the flow direction: 495 N/cm², tensile modulus in the width direction: 412 N/cm², surface was corona-treated to exhibit the wetting index of 52 mN/m, produced by Sekisui Chemical Co., Ltd.) was used instead of Black polyolefin based foam (1).

### Example 9

A double-faced adhesive tape having a thickness of 245 μm was obtained in the same manner as in Example 3 except that Black polyolefin based foam (5) (thickness: 200 μm, interlaminar strength: 27.4 N/cm, apparent density: 0.40 g/cm³, 25% compressive strength: 332 kPa, tensile strength in the flow direction: 1,072 N/cm², tensile modulus in the width direction: 675 N/cm², surface was corona-treated to exhibit the wetting index of 52 mN/m, produced by Sekisui Chemical Co., Ltd.) was used instead of Black polyolefin based foam (1).

### Example 10

A double-faced adhesive tape having a thickness of 245 μm was obtained in the same manner as in Example 3 except that Black polyolefin based foam (6) (thickness: 200 μm, interlaminar strength: 44.2 N/cm, apparent density: 0.45 g/cm³, 25% compressive strength: 450 kPa, tensile strength in the flow direction: 964 N/cm², tensile modulus in the width direction: 666 N/cm², surface was corona-treated to exhibit the wetting index of 52 mN/m, produced by Sekisui Chemical Co., Ltd.) was used instead of Black polyolefin based foam (1).

### Example 11

A double-faced adhesive tape having a thickness of 345 μm was obtained in the same manner as in Example 3 except that Black polyolefin based foam (7) (thickness: 300 μm, interlaminar strength: 22 N/cm, apparent density: 0.20 g/cm³, 25% compressive strength: 90 kPa, tensile strength in the flow direction: 530 N/cm², tensile modulus in the width direction: 340 N/cm², surface was corona-treated to exhibit the wetting index of 52 mN/m, produced by Sekisui Chemical Co., Ltd.) was used instead of Black polyolefin based foam (1).

### Example 12

A double-faced adhesive tape having a thickness of 135 μm was obtained in the same manner as in Example 3 except that the thickness of the low-adhesion adhesive layer after drying was specified to be 10 μm instead of 20 μm.

### Example 13

A double-faced adhesive tape having a thickness of 165 μm was obtained in the same manner as in Example 3 except that the thickness of the low-adhesion adhesive layer after drying was specified to be 40 μm instead of 20 μm.

### Example 14

A double-faced adhesive tape having a thickness of 175 μm was obtained in the same manner as in Example 3 except that the thickness of the low-adhesion adhesive layer after drying was specified to be 50 μm instead of 20 μm.

### Example 15

A double-faced adhesive tape having a thickness of 300 μm was obtained in the same manner as in Example 9 except that the thickness of the low-adhesion adhesive layer after drying was specified to be 50 μm instead of 20 μm and the thickness of the high-adhesion adhesive layer after drying was specified to be 50 μm instead of 25 μm.

### Example 16

A double-faced adhesive tape having a thickness of 300 μm was obtained in the same manner as in Example 10 except that the thickness of the low-adhesion adhesive layer after drying was specified to be 50 μm instead of 20 μm and the thickness of the high-adhesion adhesive layer after drying was specified to be 50 μm instead of 25 μm.

### Example 17

A double-faced adhesive tape having a thickness of 145 μm was obtained in the same manner as in Example 3 except that Adhesive composition (F) was used instead of Adhesive composition (E) and a mixture, in which 1.77 parts by mass of “Coronate L-45” (isocyanate based cross-linking agent, solid content 45%) produced by NIPPON POLYURETHANE INDUSTRY CO., LTD., was added relative to 100 parts by mass of Adhesive composition (F), was used for the high-adhesion adhesive layer. The gel fraction of the adhesive layer was 46 percent by mass and the temperature, at which the loss tangent (tan δ) at a frequency of 1 Hz exhibited a peak value, was −7° C.

### Example 18

A double-faced adhesive tape having a thickness of 145 μm was obtained in the same manner as in Example 3 except that Adhesive composition (G) was used instead of Adhesive composition (E) and a mixture, in which 1.33 parts by mass of “Coronate L-45” (isocyanate based cross-linking agent, solid content 45%) produced by NIPPON POLYURETHANE INDUSTRY CO., LTD., was added relative to 100 parts by mass of Adhesive composition (G), was used for the high-adhesion adhesive layer. The gel fraction of the adhesive layer was 37 percent by mass and the temperature, at which the loss tangent (tan δ) at a frequency of 1 Hz exhibited a peak value, was 2° C.

### Comparative Example 1

A double-faced adhesive tape having a thickness of 145 μm was obtained in the same manner as in Example 1 except that an adhesive layer formed by adding 1.78 parts by mass of “Coronate L-45” (isocyanate based cross-linking agent, solid content 45%) produced by NIPPON POLYURETHANE INDUSTRY CO., LTD., relative to 100 parts by mass of Adhesive composition (A) described above, performing agitation for 15 minutes, applying the resulting mixture to a release-treated surface of a release-treated PET film having a thickness of 75 μm in such a way that the thickness after drying became 20 μm, and performing drying at 80° C. for 3 minutes (the gel fraction was 90 percent by mass and the temperature, at which the loss tangent (tan δ) at a frequency of 1 Hz exhibited a peak value, was −35° C.) was used as the low-adhesion adhesive layer.

### Comparative Example 2

A double-faced adhesive tape having a thickness of 145 μm was obtained in the same manner as in Example 1 except that an adhesive layer formed by adding 1.33 parts by mass of “Coronate L-45” (isocyanate based cross-linking agent, solid content 45%) produced by NIPPON POLYURETHANE INDUSTRY CO., LTD., relative to 100 parts by mass of Adhesive composition (B) described above, performing agitation for 15 minutes, applying the resulting mixture to a release-treated surface of a release-treated PET film having a thickness of 75 μm in such a way that the thickness after drying became 20 μm, and performing drying at 80° C. for 3 minutes (the gel fraction was 90 percent by mass and the temperature, at which the loss tangent (tan δ) at a frequency of 1 Hz exhibited a peak value, was −35° C.) was used as the low-adhesion adhesive layer.

### Comparative Example 3

A double-faced adhesive tape having a thickness of 145 μm was obtained in the same manner as in Example 1 except that an adhesive layer formed by adding 0.34 parts by mass of “Coronate L-45” (isocyanate based cross-linking agent, solid content 45%) produced by NIPPON POLYURETHANE INDUSTRY CO., LTD., relative to 100 parts by mass of Adhesive composition (D) described above, performing agitation for 15 minutes, applying the resulting mixture to a release-treated surface of a release-treated PET film having a thickness of 75 μm in such a way that the thickness after drying became 20 μm, and performing drying at 80° C. for 3 minutes (the gel fraction was 78 percent by mass and the temperature, at which the loss tangent (tan δ) at a frequency of 1 Hz exhibited a peak value, was −26° C.) was used as the low-adhesion adhesive layer.

### Comparative Example 4

A double-faced adhesive tape having a thickness of 145 μm was obtained in the same manner as in Example 3 except that White polyolefin based foam (1) (thickness: 100 μm, apparent density: 0.27 g/cm², 25% compressive strength: 17 kPa, tensile modulus in the flow direction: 185 N/cm², tensile modulus in the width direction: 394 N/cm², interlaminar strength: 5 N/cm, surface was corona-treated to exhibit the wetting index of 52 mN/m, produced by INOAC CORPORATION) was used instead of Black polyolefin based foam (1).

### Comparative Example 5

A double-faced adhesive tape having a thickness of 145 μm was obtained in the same manner as in Example 3 except that Black polyolefin based foam (8) (thickness: 500 μm, apparent density: 0.14 g/cm³, 25% compressive strength: 98 kPa, tensile modulus in the flow direction: 411 N/cm², tensile modulus in the width direction: 245 N/cm², interlaminar strength: 30.0 N/cm, surface was corona-treated to exhibit the wetting index of 52 mN/m, produced by Sekisui Chemical Co., Ltd.) was used instead of Black polyolefin based foam (1).

### Comparative Example 6

A double-faced adhesive tape having a thickness of 185 μm was obtained in the same manner as in Example 3 except that an adhesive layer formed by adding 0.89 parts by mass of “Coronate L-45” (isocyanate based cross-linking agent, solid content 45%) produced by NIPPON POLYURETHANE INDUSTRY CO., LTD., relative to 100 parts by mass of Adhesive composition (A) described above, performing agitation for 15 minutes, applying the resulting mixture to a release-treated surface of a release-treated PET film having a thickness of 75 μm in such a way that the thickness after drying became 60 μm, and performing drying at 80° C. for 3 minutes was used as the low-adhesion adhesive layer.

### Comparative Example 7

A double-faced adhesive tape having a thickness of 70 μm was obtained in the same manner as in Example 3 except that a polyethylene terephthalate (PET) film (thickness: 25 μm, surface was corona-treated to exhibit the wetting index of 52 mN/m) was used for the low-adhesion adhesive layer instead of Black polyolefin based foam (1).

### Comparative Example 8

A double-faced adhesive tape having a thickness of 95 μm was obtained in the same manner as in Example 3 except that a polyethylene terephthalate (PET) film (thickness: 50 μm, surface was corona-treated to exhibit the wetting index of 52 mN/m) was used for the low-adhesion adhesive layer instead of Black polyolefin based foam (1).

### Comparative Example 9

A double-faced adhesive tape having a thickness of 145 μm was obtained in the same manner as in Example 1 except that Adhesive composition (E) was used instead of Adhesive composition (A) and a mixture, in which 1.1 parts by mass of “Coronate L-45” (isocyanate based cross-linking agent, solid content 45%) produced by NIPPON POLYURETHANE INDUSTRY CO., LTD., was added relative to 100 parts by mass of Adhesive composition (E), was used instead of the low-adhesion adhesive layer. The gel fraction of the adhesive layer was 48 percent by mass and the temperature, at which the loss tangent (tan δ) at a frequency of 1 Hz exhibited a peak value, was −16° C.

The foam base materials used in the above-described examples and comparative examples and the double-faced adhesive tapes obtained in the above-described examples and comparative examples were evaluated as described below. The results obtained are shown in the tables.

[Thicknesses of Foam Base Material and Adhesive Tape]

The measurement was performed with Dial Thickness gauge G produced by OZAKI MFG. CO., LTD. In the case of the adhesive tape, the measurement was performed after the release tape was peeled.

[Interlaminar Strength of Foam Base Material]

An adhesive layer was formed by adding 1.33 parts by mass of “Coronate L-45” (isocyanate based cross-linking agent, solid content 45%) produced by NIPPON POLYURETHANE INDUSTRY CO., LTD., relative to 100 parts by mass of Adhesive composition (F), performing agitation for 15 minutes, applying the resulting mixture to a release-treated PET film having a thickness of 75 μm in such a way that the thickness after drying became 50 μm, and performing drying at 80° C. for 3 minutes. Subsequently, one sheet of the above-described adhesive layer was bonded to both surfaces of the foam to be subjected to the interlaminar strength evaluation and, thereafter, lamination was performed with a roll at 23° C. and a linear pressure of 5 kgf/cm. Then, aging was performed at 40° C. for 48 hours, so that a double-faced adhesive tape for the interlaminar strength measurement was formed.

Next, the double-faced adhesive tape with a width of 1 cm and a length of 10 cm (in the flow direction of the foam base material), in which one adhesive surface is backed with a polyethylene terephthalate film (the side to be bonded to the adhesive surface was corona-treated to exhibit the wetting index of 52 mN/m) having a thickness of 25 μm, was press-bonded to a polyethylene terephthalate film (the side to be bonded to the adhesive surface was corona-treated to exhibit the wetting index of 52 mN/m) having a thickness of 50 μm in an environment at 23° C. and 50% RH by one reciprocating motion of a 2-kg roller and standing was performed at 60° C. for 48 hours. After standing at 23° C. for 24 hours, the 50-μm thickness polyethylene terephthalate film side was fixed to a test specimen mount of High-Speed Peeling Tester (TE-703 produced by TESTER SANGYO CO., LTD.) with a double-faced adhesive tape for fixing, the foam was torn (the base material was broken) by pulling the 25-μm thickness polyethylene terephthalate film side at a pulling rate of 15 m/min in the 90-degree direction and, a maximum strength at that time was measured (unit: N/cm).

[Tensile Strength]

The foam base material or the double-faced adhesive tape (release film was peeled) made into a test specimen with a gauge length of 2 cm (the flow direction and the width direction of the foam base material) and a width of 1 cm was pulled at a pulling rate of 300 mm/min, and the strength at break was measured. Then, the measured value was divided by the thickness of the foam base material to calculate the tensile strength (unit: N/cm²).

[Tensile Elongation]

The foam base material or the double-faced adhesive tape (release film was peeled) made into a test specimen with a gauge length of 2 cm in the flow direction of the foam base material and a width of 1 cm was pulled at a pulling rate of 300 mm/min, and the elongation at break was specified to be the tensile elongation.

[Average Bubble Diameter of Foam Base Material in Flow Direction and Width Direction]

The foam base material was cut into about 1 cm in both the flow direction and the width direction, the central portion in the cut surface of the resulting foam base material was magnified 200 times by a microscope (trade name “KH-7700”, produced by HIROX) and, thereafter, the cross-section of the foam base material in the width direction or the flow direction was photographed in such a way that the full length of the cut surface of the foam base material in the base material thickness direction fit into the photograph. In the resulting photograph, diameters of all bubbles present in the cut surface corresponding to the actual length of 2 mm in the flow direction or the width direction before magnification were measured, and the average bubble diameter was calculated on the basis of the average value thereof. These measurements were performed at 10 places on a random basis, and the average value thereof was specified to be the average bubble diameter in the flow direction (MD) or the width direction (CD).

[Average Bubble Diameter of Foam Base Material in Thickness Direction]

As for the average bubble diameter of the foam base material in the thickness direction, observation with the microscope was performed under the same condition as the condition of the average bubble diameter measurement in the flow direction of the foam base material. In the resulting photograph, all bubble diameters in the thickness direction of the bubbles which had been subjected to the bubble diameter measurement in the flow direction or the width direction and the average bubble diameter was calculated on the basis of the average value thereof. These measurements were performed at 10 places on a random basis, and the average value thereof was specified to be the average bubble diameter in the thickness direction (CD). Also, the result was specified to be the average bubble diameter in the thickness direction (CD).

[180° Peel Adhesion Force (Adhesive Layer)]

The 180° peel adhesion force of each adhesive layer used in the examples and the comparative examples was measured in the following method.

1) An adhesive layer was formed by adding a cross-linking agent in conformity with each of the examples and the comparative examples relative to 100 parts by mass of each adhesive composition described in the examples and the comparative examples, performing agitation for 15 minutes, applying the resulting mixture to a release-treated PET film having a thickness of 75 μm in such a way that the thickness after drying became 25 μm, and performing drying at 80° C. for 3 minutes. Subsequently, the above-described adhesive layer was bonded to a polyethylene terephthalate film (the side to be bonded to the adhesive surface was corona-treated to exhibit the wetting index of 52 mN/m) having a thickness of 25 μm and, thereafter, lamination was performed with a roll at 23° C. and a linear pressure of 5 kgf/cm. Then, aging was performed at 40° C. for 48 hours, so that an adhesive tape for the adhesion force measurement was formed.
2) The adhesive tape was press-bonded to a stainless steel sheet (SUS304, hairline-finished with #360 water resistant paper) in an environment at a temperature of 23° C. and a relative humidity of 50% RH by using a 2-kg roller with the number of press bonding cycles of one reciprocating motion.
3) After standing was performed for 1 hour at 23° C. and 50% RH, the strength at the time of peeling in the 180° direction at a pulling rate of 300 mm/min at 23° C. and 50% RH was measured (unit: N/20 mm).

[180° PEEL ADHESION FORCE (ADHESIVE TAPE)]

The 180° peel adhesion forces of adhesive tapes in the examples and the comparative examples were measured in the following method.

1) A double-faced adhesive tape sample with a width of 2 cm and a length of 10 cm (in the flow direction of the foam base material), in which the high-adhesion surface side was backed with a polyethylene terephthalate film (the side to be bonded to the adhesive surface was corona-treated to exhibit the wetting index of 52 mN/m) having a thickness of 25 μm, was press-bonded to a stainless steel sheet (SUS304, surface BA finish, hereafter the same goes) having a thickness of 1.5 mm or non-alkali glass (“EAGLE-XG” produced by Corning Incorporated) having a thickness of 0.5 mm at 23° C. and 50% RH by one reciprocating motion of a 2-kg roller.
2) After standing was performed for 1 hour at 23° C. and 50% RH, the strength at the time of peeling in the 180° direction at a pulling rate of 300 mm/min at 23° C. and 50% RH was measured (unit: N/20 mm).

[Impact Resistance Test]

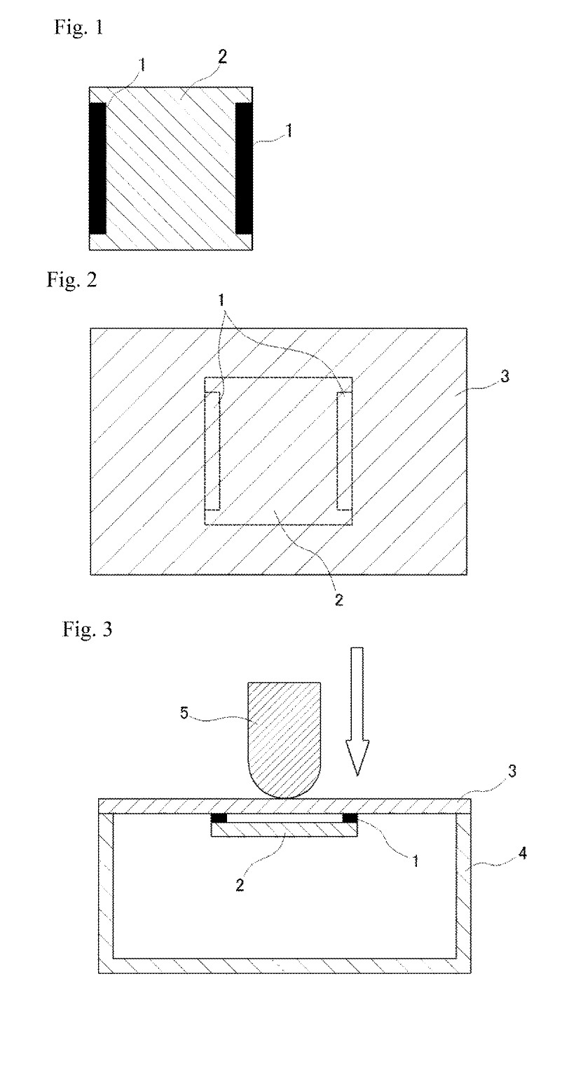

1) Low-adhesion surfaces of two double-faced adhesive tapes with a length of 40 mm and a width of 5 mm were parallel bonded with a distance of 40 mm to an acrylic board (ACRYLITE L “trademark”, MITSUBISHI RAYON CO., LTD., hue: transparent) having a thickness of 2 mm and outer dimensions of 50 mm×50 mm (FIG. 1) and, thereafter, were bonded to the central portion of an ABS board (ToughAce R “trademark”, produced by Sumitomo Bakelite Co., Ltd., hue: natural, no grain, hereafter the same goes) having a thickness of 2 mm and outer dimensions of 150 mm×100 mm (FIG. 2). Press-bonding was performed by one reciprocating motion of a 2-kg roller and, subsequently, standing was performed at 23° C. for 1 hour to prepare a test specimen.

2) A U-shaped measurement stand (made from aluminum having a thickness of 5 mm) with a length of 150 mm, a width of 100 mm, and a height of 45 mm was placed on the seat of Du Point type Impact Tester (produced by TESTER SANGYO CO., LTD.), the test specimen was placed thereon in such a way that the acrylic board pointed downward (FIG. 3). A stainless steel impact core having a diameter of 25 mm and a mass of 300 g was dropped from the ABS board side to the central portion of the ABS board 5 times at intervals of 10 seconds on a height basis, where the height was changed by 10 cm, and the height, at which peeling or breakage of the tape of the test specimen was observed, was measured.

⊙: Peeling and breakage of the tape did not occur after the test at a height of 70 cm
◯: Peeling or breakage of the tape occurred after the test at a height of 60 to 70 cm

x: Peeling or breakage of the tape occurred after the test at a height of 40 to 50 cm

xx: Peeling or breakage of the tape occurred after the test at a height of 30 cm or less

[Reworkability]

1) The low-adhesion surface of the double-faced adhesive tape having outer dimensions of 30 mm×30 mm was bonded to a non-alkali glass sheet having a thickness of 0.5 mm and outer dimensions of 30 mm×30 mm. Subsequently, bonding to a SUS sheet having a thickness of 0.5 mm and outer dimensions of 30 mm×100 mm was performed by one reciprocating motion of a 2-kg roller and, then, standing was performed at 23° C. for 24 hours to prepare a test specimen.

2) The degree of ease of peeling was evaluated, where the non-alkali glass sheet was manually peeled in the vertical direction at 23° C.

⊙: Peeling was performed at ambient temperature (23° C.) easily without breaking the non-alkali glass.

◯: Peeling was performed easily without breaking the non-alkali glass by standing the test specimen at 50° C. for 1 minute.

x: Peeling was not able to be performed even after standing at 50° C. for 1 minute and the non-alkali glass was broken.

TABLE 1

| | | | | Exam- | Exam- | Exam- | Exam- | Exam- | Exam- | Exam- | Exam- | Exam- |
|---|---|---|---|---|---|---|---|---|---|---|---|---|
| | | | | ple1 | ple2 | ple3 | ple4 | ple5 | ple6 | ple7 | ple8 | ple9 |
| Low- | Adhesive composition | | | (A) | (B) | (C) | (B) | (D) | (C) | (C) | (C) | (C) |
| adhesion | Cross-linking | | [parts | 0.89 | 0.67 | 0.89 | 0.34 | 1.33 | 0.89 | 0.89 | 0.89 | 0.89 |
| adhesive | agent content | | by mass] | | | | | | | | | |
| layer | Thickness | | [μm] | 20 | 20 | 20 | 20 | 20 | 20 | 20 | 20 | 20 |
| | 180° Peel | | [N/ | 0.5 | 0.8 | 1.6 | 2.2 | 2.5 | 1.6 | 1.6 | 1.6 | 1.6 |
| | adhesion force | | 20 mm] | | | | | | | | | |
| | Gel fraction | | [%] | 87 | 86 | 90 | 81 | 87 | 90 | 90 | 90 | 90 |
| | Elongation | | [%] | 307 | 327 | 299 | 460 | 316 | 299 | 299 | 299 | 299 |
| | at break | | | | | | | | | | | |
| High- | Adhesive | | | (E) | (E) | (E) | (E) | (E) | (E) | (E) | (E) | (E) |
| adhesion | composition | | | | | | | | | | | |
| adhesive | Thickness | | [μm] | 25 | 25 | 25 | 25 | 25 | 25 | 25 | 25 | 25 |
| layer | 180° Peel | | [N/ | 13.0 | 13.0 | 13.0 | 13.0 | 13.0 | 13.0 | 13.0 | 13.0 | 13.0 |
| | adhesion force | | 20 mm] | | | | | | | | | |
| | Gel fraction | | [%] | 48 | 48 | 48 | 48 | 48 | 48 | 48 | 48 | 48 |
| Foam base | Foam species | | | Black | Black | Black | Black | Black | Black | Black | Black | Black |
| material | | | | poly- | poly- | poly- | poly- | poly- | poly- | poly- | poly- | poly- |
| | | | | olefin | olefin | olefin | olefin | olefin | olefin | olefin | olefin | olefin |
| | | | | (1) | (1) | (1) | (1) | (1) | (2) | (3) | (4) | (5) |
| | Thickness | | [μm] | 100 | 100 | 100 | 100 | 100 | 100 | 140 | 200 | 200 |
| | Interlaminar | | [N/cm] | 12.6 | 12.6 | 12.6 | 12.6 | 12.6 | 8.9 | 19.1 | 12.9 | 27.4 |
| | strength | | | | | | | | | | | |
| | Apparent density | | [g/cm3] | 0.40 | 0.40 | 0.40 | 0.40 | 0.40 | 0.33 | 0.40 | 0.20 | 0.40 |
| | 25% Compressive | | [kPa] | 103 | 103 | 103 | 103 | 103 | 70 | 130 | 52 | 332 |
| | strength | | | | | | | | | | | |
| | Average | MD | [μm] | 126 | 126 | 126 | 126 | 126 | 189 | 147 | 173 | 129 |
| | bubble | CD | [μm] | 143 | 143 | 143 | 143 | 143 | 189 | 174 | 210 | 131 |
| | diameter | VD | [μm] | 20 | 20 | 20 | 20 | 20 | 27 | 33 | 42 | 39 |
| | Tensile | MD | [N/cm²] | 1084 | 1084 | 1084 | 1084 | 1084 | 799 | 994 | 495 | 1072 |
| | strength | CD | [N/cm²] | 790 | 790 | 790 | 790 | 790 | 627 | 713 | 412 | 675 |
| | Strength | MD | [N/cm] | 10.8 | 10.8 | 10.8 | 10.8 | 10.8 | 8.0 | 9.9 | 5.0 | 10.7 |
| | at break | CD | [N/cm] | 7.9 | 7.9 | 7.9 | 7.9 | 7.9 | 6.3 | 7.1 | 4.1 | 6.8 |
| | Tensile | MD | [%] | 508 | 508 | 508 | 508 | 508 | 458 | 535 | 445 | 915 |
| | elongation | CD | [%] | 224 | 224 | 224 | 224 | 224 | 254 | 344 | 261 | 432 |
| Adhesive | Tape total | | [μm] | 145 | 145 | 145 | 145 | 145 | 145 | 185 | 245 | 245 |
| tape | thickness | | | | | | | | | | | |
| | 180° Peel | SUS | [N/ | 0.5 | 0.8 | 1.1 | 2.3 | 2.1 | 1.3 | 1.7 | 4.0 | 3.7 |
| | adhesion | | 20 mm] | | | | | | | | | |
| | force | Glass | [N/ | 0.4 | 0.7 | 0.7 | 2.0 | 2.0 | 1.2 | 1.5 | 1.9 | 3.6 |
| | | | 20 mm] | | | | | | | | | |

| | | | | | | | | | |
|---|---|---|---|---|---|---|---|---|---|
| Impact resistance test | ◯ | ⊙ | ⊙ | ⊙ | ⊙ | ⊙ | ⊙ | ⊙ | ⊙ |
| Reworkability test | ⊙ | ⊙ | ⊙ | ◯ | ◯ | ◯ | ◯ | ⊙ | ◯ |

TABLE 2

| | | | | Exam- | Exam- | Exam- | Exam- | Exam- | Exam- | Exam- | Exam- | Exam- |
|---|---|---|---|---|---|---|---|---|---|---|---|---|
| | | | | ple10 | ple11 | ple12 | ple13 | ple14 | ple15 | ple16 | ple17 | ple18 |
| Low- | Adhesive composition | | | (C) | (C) | (C) | (C) | (C) | (C) | (C) | (C) | (C) |
| adhesion | Cross-linking | | [parts | 0.89 | 0.89 | 0.89 | 0.89 | 0.89 | 0.89 | 0.89 | 0.89 | 0.89 |
| adhesive | agent content | | by mass] | | | | | | | | | |
| layer | Thickness | | [μm] | 20 | 20 | 10 | 40 | 50 | 50 | 50 | 20 | 20 |
| | 180° Peel | | [N/ | 1.6 | 1.6 | 1.6 | 1.6 | 1.6 | 1.6 | 1.6 | 1.6 | 1.6 |
| | adhesion force | | 20 mm] | | | | | | | | | |
| | Gel fraction | | [%] | 90 | 90 | 90 | 90 | 90 | 90 | 90 | 90 | 90 |
| | Elongation | | [%] | 299 | 299 | 299 | 299 | 299 | 299 | 299 | 299 | 299 |
| | at break | | | | | | | | | | | |
| High- | Adhesive | | | (E) | (E) | (E) | (E) | (E) | (E) | (E) | (F) | (G) |
| adhesion | composition | | | | | | | | | | | |
| adhesive | Thickness | | [μm] | 25 | 25 | 25 | 25 | 25 | 50 | 50 | 25 | 25 |
| layer | 180° Peel | | [N/ | 13.0 | 13.0 | 13.0 | 13.0 | 13.0 | 13.0 | 13.0 | 11.0 | 16.0 |
| | adhesion force | | 20 mm] | | | | | | | | | |
| | Gel fraction | | [%] | 48 | 48 | 48 | 48 | 48 | 48 | 48 | 46 | 37 |
| Foam base | Foam species | | | Black | Black | Black | Black | Black | Black | Black | Black | Black |
| material | | | | poly- | poly- | poly- | poly- | poly- | poly- | poly- | poly- | poly- |
| | | | | olefin | olefin | olefin | olefin | olefin | olefin | olefin | olefin | olefin |
| | | | | (6) | (7) | (1) | (1) | (1) | (5) | (6) | (1) | (1) |
| | Thickness | | [μm] | 200 | 300 | 100 | 100 | 100 | 200 | 200 | 100 | 100 |
| | Interlaminar | | [N/cm] | 44.2 | 22 | 12.6 | 12.6 | 12.6 | 27.4 | 44.2 | 12.6 | 12.6 |
| | strength | | | | | | | | | | | |
| | Apparent density | | [g/cm3] | 0.45 | 0.20 | 0.40 | 0.40 | 0.40 | 0.40 | 0.45 | 0.40 | 0.40 |
| | 25% Compressive | | [kPa] | 450 | 90 | 103 | 103 | 103 | 332 | 450 | 103 | 103 |
| | strength | | | | | | | | | | | |
| | Average | MD | [μm] | 80 | 113 | 126 | 126 | 126 | 129 | 80 | 126 | 126 |
| | bubble | CD | [μm] | 87 | 124 | 143 | 143 | 143 | 131 | 87 | 143 | 143 |
| | diameter | VD | [μm] | 27 | 57 | 20 | 20 | 20 | 39 | 27 | 20 | 20 |
| | Tensile | MD | [N/cm²] | 964 | 530 | 1084 | 1084 | 1084 | 1072 | 964 | 1084 | 1084 |
| | strength | CD | [N/cm²] | 666 | 340 | 790 | 790 | 790 | 675 | 666 | 790 | 790 |
| | Strength | MD | [N/cm] | 14.2 | 5.1 | 10.8 | 10.8 | 10.8 | 10.7 | 14.2 | 10.8 | 10.8 |
| | at break | CD | [N/cm] | 8.7 | 4.2 | 7.9 | 7.9 | 7.9 | 6.8 | 8.7 | 7.9 | 7.9 |
| | Tensile | MD | [%] | 669 | 530 | 508 | 508 | 508 | 915 | 669 | 508 | 508 |
| | elongation | CD | [%] | 440 | 420 | 224 | 224 | 224 | 432 | 440 | 224 | 224 |
| Adhesive | Tape total | | [μm] | 245 | 345 | 135 | 165 | 185 | 300 | 300 | 145 | 145 |
| tape | thickness | | | | | | | | | | | |
| | 180° Peel | SUS | [N/ | 3.3 | 5.3 | 0.7 | 2.5 | 3.0 | 4.5 | 4.2 | 1.0 | 1.2 |
| | adhesion | | 20 mm] | | | | | | | | | |
| | force | Glass | [N/ | 3.1 | 3.6 | 0.5 | 2.4 | 2.8 | 4.2 | 4.0 | 1.2 | 0.8 |
| | | | 20 mm] | | | | | | | | | |

| | | | | | | | | | |
|---|---|---|---|---|---|---|---|---|---|
| Impact resistance test | ⊙ | ⊙ | ⊙ | ⊙ | ⊙ | ⊙ | ⊙ | ⊙ | ⊙ |
| Reworkability test | ◯ | ◯ | ⊙ | ⊙ | ◯ | ◯ | ◯ | ⊙ | ⊙ |

TABLE 3

| | | | | Compar- | Compar- | Compar- | Compar- | Compar- | Compar- | Compar- | Compar- | Compar- |
|---|---|---|---|---|---|---|---|---|---|---|---|---|
| | | | | ative | ative | ative | ative | ative | ative | ative | ative | ative |
| | | | | exam- | exam- | exam- | exam- | exam- | exam- | exam- | exam- | exam- |
| | | | | ple1 | ple2 | ple3 | ple4 | ple5 | ple6 | ple7 | ple8 | ple9 |
| Low- | Adhesive composition | | | (A) | (B) | (D) | (C) | (C) | (C) | (C) | (C) | (E) |
| adhesion | Cross-linking | | [parts | 1.78 | 1.33 | 0.34 | 0.89 | 0.89 | 0.89 | 0.89 | 0.89 | 1.10 |
| adhesive | agent content | | by mass] | | | | | | | | | |
| layer | Thickness | | [μm] | 20 | 20 | 20 | 20 | 20 | 60 | 20 | 20 | 20 |
| | 180° Peel | | [N/ | 0.1 | 0.4 | 5.0 | 1.6 | 1.6 | 1.6 | 1.6 | 1.6 | 13.0 |
| | adhesion force | | 20 mm] | | | | | | | | | |
| | Gel fraction | | [%] | 90 | 90 | 78 | 90 | 90 | 90 | 90 | 90 | 48 |
| | Elongation | | [%] | 116 | 189 | 709 | 299 | 299 | 299 | 299 | 299 | 2160 |
| | at break | | | | | | | | | | | |
| High- | Adhesive | | | (E) | (E) | (E) | (E) | (E) | (E) | (E) | (E) | (E) |
| adhesion | composition | | | | | | | | | | | |
| adhesive | Thickness | | [μm] | 25 | 25 | 25 | 25 | 25 | 25 | 25 | 25 | 25 |
| layer | 180° Peel | | [N/ | 13.0 | 13.0 | 13.0 | 13.0 | 13.0 | 13.0 | 13.0 | 13.0 | 13.0 |
| | adhesion force | | 20 mm] | | | | | | | | | |
| | Gel fraction | | [%] | 48 | 48 | 48 | 48 | 48 | 48 | 48 | 48 | 48 |
| Foam base | Foam species | | | Black | Black | Black | Black | Black | Black | Trans- | Trans- | Black |
| material | | | | poly- | poly- | poly- | poly- | poly- | poly- | parent | parent | poly- |
| | | | | olefin | olefin | olefin | olefin | olefin | olefin | PET | PET | olefin |
| | | | | (1) | (1) | (1) | (1) | (8) | (1) | 25 μm | 50 μm | (1) |
| | Thickness | | [μm] | 100 | 100 | 100 | 100 | 500 | 100 | 25 | 50 | 100 |
| | Interlaminar | | [N/cm] | 12.6 | 12.6 | 12.6 | 5 | 30 | 12.6 | — | — | 12.6 |
| | strength | | | | | | | | | | | |
| | Apparent density | | [g/cm3] | 0.40 | 0.40 | 0.40 | 0.27 | 0.14 | 0.40 | — | — | 0.40 |
| | 25% Compressive | | [kPa] | 103 | 103 | 103 | 17 | 98 | 103 | — | — | 103 |
| | strength | | | | | | | | | | | |
| | Average | MD | [μm] | 126 | 126 | 126 | 45 | 113 | 126 | — | — | 126 |
| | bubble | CD | [μm] | 143 | 143 | 143 | 28 | 124 | 143 | — | — | 143 |
| | diameter | VD | [μm] | 20 | 20 | 20 | 9 | 57 | 20 | — | — | 20 |
| | Tensile | MD | [N/cm²] | 1084 | 1084 | 1084 | 185 | 411 | 1084 | — | — | 1084 |
| | strength | CD | [N/cm²] | 790 | 790 | 790 | 394 | 245 | 790 | — | — | 790 |
| | Strength | MD | [N/cm] | 10.8 | 10.8 | 10.8 | 1.9 | 20.6 | 10.8 | — | — | 10.8 |
| | at break | CD | [N/cm] | 7.9 | 7.9 | 7.9 | 3.9 | 12.3 | 7.9 | — | — | 7.9 |
| | Tensile | MD | [%] | 508 | 508 | 508 | 118 | 615 | 508 | — | — | 508 |
| | elongation | CD | [%] | 224 | 224 | 224 | 115 | 620 | 224 | — | — | 224 |
| Adhesive | Tape total | | [μm] | 145 | 145 | 145 | 145 | 545 | 185 | 70 | 95 | 145 |
| tape | thickness | | | | | | | | | | | |
| | 180° Peel | SUS | [N/ | 0.1 | 0.4 | 4.3 | 1.1 | 4.8 | 3.4 | 0.7 | 0.4 | 11.2 |
| | adhesion | | 20 mm] | | | | | | | | | |
| | force | Glass | [N/ | 0.1 | 0.4 | 3.6 | 1.1 | 4.1 | 3.3 | 0.8 | 0.6 | 12.0 |
| | | | 20 mm] | | | | | | | | | |

| | | | | | | | | | |
|---|---|---|---|---|---|---|---|---|---|
| Impact resistance test | X X | X X | ⊙ | X X | ⊙ | ⊙ | X X | X X | ⊙ |
| Reworkability test | ⊙ | ⊙ | X | X | X | X | ⊙ | ⊙ | X |

As is clear from Examples 1 to 18 described above, the adhesive tapes according to the present invention exhibited excellent impact resistance and adherend-conformability and, in addition, favorable reworkability. On the other hand, the adhesive tapes of Comparative examples 1 to 9 did not exhibit favorable impact resistance, conformability, and reworkability in combination.

### REFERENCE SIGNS LIST

1 adhesive tape
2 acrylic board
3 ABS board
4 U-shaped measurement stand
5 impact core

1. An adhesive tape comprising an adhesive layer on at least one surface of a foam base material,
wherein the foam base material is a foam base material having a thickness of 300 μm or less and an interlaminar strength of 6 to 50 N/cm, and
the adhesive layer is an adhesive layer having a thickness of 50 μm or less and a 180° peel adhesion force of 0.5 to 4 N/20 mm at a peel rate of 300 mm/min, where the adhesive tape, which is formed by disposing the adhesive layer having a thickness of 25 μm on a PET base material having a thickness of 25 μm, is press-bonded to a SUS sheet in an environment at a temperature of 23° C. and a relative humidity of 65% RH by using a 2-kg roller with the number of press bonding cycles of one reciprocating motion and standing is performed for 1 hour in an environment at a temperature of 23° C. and a relative humidity of 50% RH.

2. The adhesive tape according to claim 1, wherein the 25% compressive strength of the foam base material is 30 kPa or more.

3. The adhesive tape according to claim 1, wherein the apparent density of the foam base material is 0.1 to 0.7 g/cm³.

4. The adhesive tape according to claim 1, wherein the foam base material is a polyolefin based foam base material.

5. The adhesive tape according to claim 1, comprising adhesive layers on both surfaces of the foam base material.

6. The adhesive tape according to claim 5, wherein the adhesive layer on one surface of the foam base material is an adhesive layer having a 180° peel adhesion force of 1 to 25 N/20 mm at a peel rate of 300 mm/min, where the adhesive tape, which is formed by disposing the adhesive layer having a thickness of 25 μm on a PET base material having a thickness of 25 μm, is press-bonded to a SUS sheet in an environment at a temperature of 23° C. and a relative humidity of 50% RH by using a 2-kg roller with the number of press bonding cycles of one reciprocating motion and standing is performed for 1 hour in an environment at a temperature of 23° C. and a relative humidity of 50% RH, and having an adhesion force higher than the adhesion force of the adhesive layer on the other surface.

7. The adhesive tape according to claim 1, wherein the adhesive tape is used for fixing a tabular rigid body.
